(19) United States
(12) Patent Application Publication
(10) Pub. No.: US 2004/0260781 A1
(43) Pub. Date: Dec. 23, 2004

(54) Web based dating service with weighted interests matching

(76) Inventors: Ronald N. Shostack, Los Angeles, CA (US); Sean G. Renet, Los Angeles, CA (US); Anthony Rennert, Marina del Rey, CA (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/740,174

(22) Filed: Dec. 18, 2003

Related U.S. Application Data
(63) Continuation-in-part of application No. 10/632,771, filed on Aug. 1, 2003.
Application No. 10/632,771 is a continuation-in-part of application No. 09/826,230, filed on Apr. 4, 2001.
(60) Provisional application No. 60/255,672, filed on Dec. 14, 2000.

(51) Int. Cl. G06F 15/16

(52) U.S. Cl. 709/207

(57) ABSTRACT

A dating related web site incorporates a number of services of interest to subscribers seeking a compatible mate or friend. A would-be subscriber first specifies profile information including authentication information, information relating to qualities desired in a friend and mate, the relative importance of the respective categories, and a screen image icon. The profile information is stored in a database associate with a web server hosting the dating site. The subscriber can then log onto the site and advantage the of chat room environments featured at the site. Rooms are hierarchically organized into lobbies and sub-lobbies corresponding to topics and sub-topics of discussion. In addition, the lobby and sub-lobby screens indicate the concentration of compatible participants in the rooms of corresponding lobbies and sub-lobbies, thus allowing easy navigation to a desirable room. In addition to manual navigation, the site features automatic navigation allowing the user to find a chat room with compatible participants automatically once a sub-lobby is selected. Upon participating in a chat session, the user and a participant may choose a “virtual date” option featured at the site to take advantage of a private chat environment and to view a private, date-related video clip. “Physical Attractiveness” criteria also permit the subscriber to screen members in the database based on community ratings of the physical attractiveness of the members and to limit access to the subscriber's profile to members having a physical attractiveness ranking within a user-selected range around that of the physical attractiveness ranking for the subscriber.

### RELATED APPLICATIONS

This application is a continuation-in-part patent application of U.S. patent application Ser. No. 10/632,771, filed Aug. 1, 2003, entitled “Web-Based Dating Service With Filter For Filtering Potential Friends/Mates Using Physical Attractiveness Criteria,” which, in turn, is a continuation-in-part application of U.S. patent application Ser. No. 09/826,230, filed Apr. 4, 2001, which, in turn, claims the benefit of U.S. Provisional Patent Application Ser. No. 60/255,672, filed Dec. 14, 2000, entitled “Web-Based Dating Service.”

### FIELD OF THE INVENTION

This invention relates generally to the field of Internet dating services and to services designed to facilitate a compatible matching amongst individuals seeking companionship via the World Wide Web.

### BACKGROUND OF THE INVENTION

Recent technological advances have raised productivity levels, leading to an economic boom continuing through much of the past decade. While these advances have raised the standard of living for significant segments of the population, they have not, in general, reduced the number of hours that people work. As a result, finding the time to find a compatible mate, or viable friendship, remains as challenging as ever. In fact, as the structural economic changes experienced in recent years have led to greater geographic mobility amongst the work force, the establishment of personal relationships has become all the more difficult.

Recently, a variety of Internet related services have been offered to alleviate these problems. For example, various World Wide Web portals feature “chat rooms” allowing members of an Internet subscriber community to chat in real time. During a typical “chat room” session, a computer user with Internet access first logs in, and is then presented with a screen showing real time messages sent from other users. The messages are displayed in serial fashion along with a “handle” identifying each message sender. Thus, any user can direct a message to any other particular user, and choose to strike up a chat based on the content of the displayed message. Individuals thus have at their disposal a readily accessible, convenient form of “virtual conversation” that may be used to identify potential companions or acquaintances.

Unfortunately, although helpful, finding potential mates or companions using the Internet is sometimes still difficult. In particular, chat communities, including those featured on dating-related web sites, have proliferated to include enormous numbers of members, each generating message information in relatively undifferentiated, disorganized fashion. Consequently, finding compatible chat members may take time. Further, once a pair of users find one another and strike up a virtual conversation, the continuous stream of messages from other users may prove distracting.

Thus, what is needed is an integrated package of Internet-based date related services specifically designed to facilitate finding a suitable mate or companion. Such an integrated package would provide easily visible, continually updated compatibility-screening information for each participant in a chat environment, and could optionally guide participants to chat rooms having other compatible participants. Further, once a compatible participant is found, the package of services would preferably provide an environment conducive to one-to-one conversation and to eliciting discussion of the type of subject matter useful in determining whether to pursue a relationship further.

Physical appearance remains a significant criterion when finding the perfect friend or mate, yet conventional on-line dating services are notoriously bad at accounting for physical appearance in finding a friend or mate. In the current state of online dating, members search the database of the online dating site for other members who meet specified objective physical criteria. For example, a member may select to see all profiled members who have blonde hair and are of a medium body type and are between 5′2″ and 5′5″. A problem exists in that, since some on-line dating sites have millions of members, the list of qualifying members returned in response to a member's query may be very long, numbering several hundred members for a given search. Many of the list of otherwise qualifying members may be people to whom the searching member is not physically attracted. Presently, no effective mechanism exists by which searching members can instruct the online dating site to narrow the list of otherwise qualifying members by the factor of whether the searching member is likely to judge them to be physically attractive. Likewise, no mechanism exists in the current state of chat to effectively judge compatibility to other chat members, particularly where physical attractiveness is a criterion.

Another problem exists in the online dating environment whereby members are approached by other members though the approached member may not be physically attracted to the approaching member. In offline situations, an additional set of information exists by which one person may receive clues not to approach another person. Such clues may include a lack of attention directed to the potential approaching person, closed body language, and the like. No such additional information is generally available to users of online dating services. Some members will add notations stating that they do not wish members to contact them unless the member has a reasonable belief that the approached member will find them attractive. Lacking information as to how the general population of members may judge a given member, the searching member has no reliable method to determine such a belief. A solution is thus needed to assist members in specifying their perspective concerning the group of members to whom they may or may not be physically attracted.

Recent studies have proven the ages old hypothesis that likes attract. A recent study at Cornell University has shown that however students rated themselves on wealth and status, attractiveness, family commitment, and sexual fidelity, that is what they wanted in a mate. The problem with an approach in which individuals look for mates who resemble themselves is that individuals are notoriously bad at self-evaluation, particularly when it comes to physical appearance. Accordingly, the present invention employs the reasoning that members are a good judge of the physical attractiveness of other members and seeks to tabulate the opinions of the community of members about the physical attractiveness of other members. The tabulated opinion data is then related to members' individual preferences concerning the group of members they may find physically attractive.

Currently, operators of online dating sites have begun to employ a “community evaluation” method by which the site highlights members who appear of interest to other members whose criteria is similar to the member who is conducting a search for a mate. The method employed by such sites is primarily to measure the number of approaches made by the pool of members to other members. To facilitate this evaluation, such online dating sites have recently installed or made more prominent “Quick Messages” by which a member can let another member know of their interest by simply clicking on the Quick Message button. These clicks are tallied and a conclusion is drawn that a given member is determined attractive or otherwise popular to the membership pool of potential mates.

An example of a conventional web site that extends such a “community evaluation” method to account for members' physical attractiveness is a website found at www.hotornot.com. This site provides a member's picture and then solicits the community to provide a numerical ranking of the member's physical attractiveness. As shown in a sample screen shot in FIG. 1, a member's picture is displayed and the member community is offered the opportunity to provide a physical attractiveness rank from 1 through 10. Once a member of the community provides a ranking, the website displays the overall ranking assigned by the community and the ranking provided by the member providing the ranking. This information also may be displayed for a previous member in the vertical picture at the left of the screen shot.

The “hot or not” site also operates a dating service which is found at www.meetme.hotornot.com. As illustrated in FIG. 2, the “meet me” site asks the community whether it wishes to meet the featured member. There are two possible responses—Yes or No. If the respondent selects No, no further action is taken and the next featured member is displayed. However, if the respondent selects Yes, then he or she is asked to become a member of the “meet me” site. Upon signing up as a new member, the user is taken to a screen displaying a picture of an existing member as shown in FIG. 2. The site asks whether the user wants to meet the featured member and the user selects Yes or No. In the case illustrated in FIG. 3, the user has selected Yes. The picture of the new member is sent to the member whom the user wished to meet and the latter member is then able to select Yes or No to whether they want to meet the new member. If the latter member selects No, no further action is taken. However, if the latter member selects Yes, then an email exchange is begun with the intention of further conversation which may lead to a meeting in person.

The next screen to appear (FIG. 4) informs the user that his or her request has been passed to the featured member. If the featured member also wants to meet the user, the user will be notified by way of inclusion of the featured member in the user's “double-match” list which is accessible on the left side of the screen shot illustrated in FIG. 4. A “Meet People” option also located at the left side of the screen shot in FIG. 4 puts the user back in the mode of selecting members he or she wishes to meet.

In the case of both “hot or not” sites, a member is not afforded the opportunity to search through the member community and to receive profiles that have been selected or deselected on the basis of physical attractiveness. Further, a member is not provided with a capability to exclude his or her profile from viewing or contact by members based on the community's judgment as to the physical attractiveness of the member.

Another approach to including physical attractiveness as a criterion in online dating is implemented in the “Appearance” portion of the website of www.match.com. Match.com's search capability relative to physical attractiveness is shown in FIG. 5. As illustrated, members can narrow their search results by the criteria of Height, Eye Color, Hair Color, and Body Type. However, no provision has been made to search the Match.com database for physical attractiveness as determined by the community of Match.com members.

Of course, physical attractiveness is not the only relevant criterion for determining the compatibility of members of an on-line dating service. Conventional on-line dating systems prospective members to complete personal evaluation sheets setting for the prospective member's likes and dislikes. Unfortunately, to date, such on-line dating systems do not use the inputted data in any sophisticated way. For example, compatibility of respective members has been computed based on a true/false response set for each member relative to a set of pre-defined interests. Each interest would be examined for each member combination and aggregated to a total number of common selected interests. Since not all areas of interest are given the same weights by prospective members, a more sophisticated approach is desired whereby prospective members to an on-line dating service may specify not only their likes and dislikes but also may specify the relative weightings of such possible interests. For example, it is desired that a prospective member may specify not only that he or she is interested in movies but that attending movies is his or her favorite way to spend free time.

Accordingly, a need exists for a web based dating service that permits a member to provide customized relative weightings of possible interest categories in establishing the member's profile to other members and by which to filter the result of searches conducted to find friends or mates in on-line matching systems. The present invention addresses this need in the art.

### SUMMARY OF THE INVENTION

The present invention addresses the above described needs in the art. In particular, in accordance with a first aspect of the present invention, a web site provider establishes a site customized to facilitate finding a companion or potential mate. The site provides functionality for determining whether a first and second subscriber are a relationship match, the extent to which the first and second subscribers are likely to be compatible on a friendship level and whether or not the level of friendship compatibility exceeds certain thresholds.

To use the site, would-be subscribers first register with the site by creating a profile of information specifying the qualities they deem desirable in a mate or companion, as well as the relative significance of such qualities to other qualities. Once registered, the subscribers have access to, and may participate in, various chat room environments.

In accordance with a second aspect of the present invention, chat rooms are preferably arranged in hierarchical fashion such that each room belongs to a “sub-lobby” and each “sub-lobby” belongs to a “lobby.” The lobbies each preferably correspond to respective categories of discussion topics, with each sub-lobby designating sub-categories of discussion topics within the larger categories. In this way, a subscriber can easily navigate to a chat room dedicated to a topic of interest to the subscriber.

Further, in a third aspect of the present invention, during such user navigation, lobby, sub-lobby and room selection screens feature displayed indicators showing the concentration of participants compatible with the user in each respective lobby, sub-lobby or chat room. Such compatibility indicators are determined by comparison of the user's profile with that of the current chat participants. In this way, a subscriber can navigate to a chat room having high concentration of potential mates or friends participating.

In a fourth aspect of the present invention, a subscriber also preferably has the option to avoid manual navigation altogether by allowing the service to determine automatically the chat room having the highest concentration of compatible mates and/or friends. Once the room is determined, a screen corresponding to the determined room is displayed and the subscriber can accordingly participate in the chat.

In a fifth aspect of the present invention, the site provider also features a “virtual date” service whereby two chat participants choosing to do so can engage in a private chat and at the same time view a digital video clip corresponding to a romantic vacation. The one-one chat environment eliminates the distraction that may result when chat messages are continuously generated by numerous chat participants. Further, the video clip provides a convenient topic for discussion that may reveal further details about a potential mate.

In a sixth aspect of the present invention, a method is provided for establishing/judging member profiles based on community opinions as to individual members' physical attractiveness. The same method can be applied to other standards such as likeability, “coolness” factor, etc. Two different approaches are taken in implementing this “physical attractiveness” evaluation, each relying on a pairing of the concepts of community opinion and individual rank whereby one can determine the suitability of members to other members by reference to community-based opinions of the physical attractiveness of members. In particular, methods are described herein for predicting the likelihood that a specific member will find other specific members to be physically attractive and the member database is searched using such criteria. Physical attractiveness criteria are also used to limit the disclosure of a particular member's profile to other members in a chat room environment.

In accordance with a seventh, and presently preferred, aspect of the invention, a method and web-based server apparatus programmed to match members of an online community based on interest and or activity based compatibility to each other is provided. In accordance with this embodiment of the method of the invention, input is accepted from respective members indicating the degree of subscription or non-subscription the respective members have to predetermined interests on a scale of least interested to most interested and/or indicating the amount of importance the member ascribes to participation in a respective activities on a scale of least important to most important, and interest-based and/or activity based compatibility between members is determined by comparing scaled inputs for respective interests and/or activities based on at least one of a total number of matching interests and activities and a degree of alignment among matching interests and activity importance indicators. Members of the online community are then matched on the basis of the determined interest-based compatibility and/or the determined activity-based compatibility.

Further features and advantages of a system and method implemented in accordance with the present invention are made apparent in the more detailed description below.

### BRIEF DESCRIPTION OF THE DRAWINGS

The features and advantages of the web-based dating service of the invention will be apparent to those skilled in the art based on the following description and the accompanying drawings, of which:

FIG. 1 illustrates a sample screen shot of the “hot or not” website, where a member's picture is displayed and the member community is offered the opportunity to provide a physical attractiveness rank from 1 through 10.

FIG. 2 illustrates a sample screen shot of the “meet me” portion of the “hot or not” website that asks members of the community whether they wish to meet the featured member.

FIG. 3 illustrates a sample screen shot of the case where the member selects “yes” in response to the request of FIG. 2 to meet the featured member.

FIG. 4 illustrates a sample screen shot that informs the user that his or her request to meet a featured member has been passed to the featured member.

FIG. 5 illustrates a sample screen shot where a member provides data input relating to physical appearance at the Match.com website for use in a search relating to a member's physical appearance.

FIG. 6 is a high level overview of a network environment in which aspects of the present invention may be implemented.

FIG. 7 is a block diagram depicting components of the client stations shown in FIG. 6 in greater detail.

FIG. 8 is a high level flow chart depicting a process of a user profile creation in accordance with an aspect of the present invention.

FIG. 9 is a high level flow chart depicting a process of user navigation to a desirable chat room environment in accordance with an aspect of the present invention.

FIG. 10 is a high level flow chart depicting in greater detail the step of determining the concentration of compatible participants in available chat rooms shown in FIG. 9.

FIG. 11 is a high level flow chart depicting in greater detail the step of determining a desirable chat room environment automatically as shown in FIG. 9.

FIG. 12a is a high level flow chart depicting in greater detail the step of determining the extent to which a user and a participant are a relationship match as shown in FIG. 11.

FIG. 12b is a high level flow chart depicting in greater detail the step of determining the extent to which a user and participant are a friendship match as shown in FIG. 11.

FIG. 13 is a high level flow chart depicting a user initiation of a virtual date in accordance with an embodiment of the present invention.

FIGS. 14 and 14a are web page interfaces that may be used to perform the step of selecting and forwarding a new or existing registered subscriber choice as depicted in FIG. 8.

FIGS. 15 and 15a are web page interfaces that may be used to perform the step of selecting and forwarding a screen name, password and e-mail address during registration as depicted in FIG. 8.

FIG. 16 is a web page interface that may be used to perform the step of selecting and forwarding a relationship basics choice, friendship preferences choice or screen image choice as depicted in FIG. 8.

FIGS. 16a and 16b are player profile web page interfaces that may be used as alternatives to that shown in FIG. 16.

FIG. 17 is a web page interface that may be used to perform the step of selecting and forwarding a first set of relationship basics information as depicted in FIG. 8.

FIG. 18 is a web page interface that may be used to perform the step of selecting and forwarding a second set of relationship basics information as depicted in FIG. 8.

FIGS. 18a-18c are alternative web page interfaces that may be used to perform the step of selecting and forwarding the information depicted in FIGS. 17 and 18.

FIGS. 18d-18f are alternative web page interfaces that may be used to perform the step of selecting and forwarding the information depicted in FIGS. 17 and 18.

FIG. 19 is a web page interface that may be used to perform the step of selecting and forwarding friendship preferences information as depicted in FIG. 8.

FIGS. 19a-19c are alternative web page interfaces that may be used to perform the step of selecting and forwarding the information depicted in FIG. 19.

FIGS. 19d-19e are alternative web page interfaces that may be used to permit the user to specify his/her interests and pursuits on a weighted scale so as to permit increased selectivity in a compatibility search.

FIG. 20 is web page interface that may be used to perform the step of selecting and forwarding a screen image icon as depicted in FIG. 8.

FIG. 20a is an alternative web page interface that may be used to perform the step of selecting and forwarding a screen image icon as depicted in FIG. 8.

FIGS. 21 and 21a are web page interfaces that may be used to perform the step of selecting and forwarding a lobby identification as depicted in FIG. 9.

FIGS. 22 and 22a are web page interfaces that may be used to perform the step of selecting and forwarding a sub-lobby identification as depicted in FIG. 9.

FIGS. 23 and 23a are web page interfaces that may be used to perform the step of choosing a chat room as depicted in FIG. 9.

FIG. 24 is a web page interface that may be used to perform the step of providing a chat room page corresponding to a determined chat room as depicted in FIG. 9.

FIGS. 24a and 24b are alternative web page interfaces that may be used to perform the step of providing a chat room page corresponding to a determined chat room as depicted in FIG. 9.

FIGS. 24c and 24d are web page interfaces that may be used to perform the step of sending a private message to a chat participant.

FIGS. 24e and 24f are web page interfaces that may be used to perform the step of inviting a chat participant to a private chat room.

FIG. 24g is a web page interface that may be used to perform the step of initiating a virtual date.

FIG. 24h is a web page interface that may be used to perform the step of selecting a virtual date activity type.

FIG. 24i is a web page interface that may be used to perform the step of selecting an interactive movie for a virtual date.

FIG. 24j is a web page interface that may be used to perform the step of selecting an interactive figure to be featured in an interactive movie.

FIG. 24k is a web page interface that may be used to implement a virtual date in accordance with an embodiment of the preset invention.

FIG. 25 depicts a set of Internet relay chat servers configured in a spanning tree formation.

FIG. 26 is a web page interface that may be presented to an existing registered user of a dating related web site upon log-in in accordance with an embodiment of the present invention.

FIG. 27 illustrates a sample profile screen for a hypothetical member.

FIG. 28 illustrates a sample screen on which the user can provide a specific ranking of the degree to which the user finds the indicated member to be physically attractive in accordance with a first embodiment of the invention.

FIG. 29 illustrates a sample screen where users can input search criteria employing the criteria of physical attractiveness to filter the list of members in the member database in accordance with the first embodiment.

FIG. 30 illustrates a sample screen where users can input parameters to restrict the display of their profile to other members within the member database based on the other members' physical attractiveness in accordance with the first embodiment.

FIG. 31 illustrates a sample screen showing those members meeting the user's selected physical attractiveness criteria and any other selected criteria that are found in a search of the member database.

FIG. 32 illustrates a sample screen through which users can restrict the display of their profile while in a chat room to other members within the member database based on the other members' physical attractiveness in accordance with the first embodiment.

FIG. 33 illustrates a sample screen showing those members who appear to a particular user in a chat room based on display criteria including each member's physical attractiveness and member selections concerning display of their profile while in chat rooms.

FIG. 34 illustrates a sample screen on which the user can provide a specific ranking of the degree to which the user finds the indicated member to be physically attractive in accordance with a second embodiment.

FIG. 35 illustrates a sample screen where users can input search criteria employing the criteria of physical attractiveness to filter the list of members from the member database in accordance with the second embodiment.

FIG. 36 illustrates a sample screen where users can input parameters to restrict the display of their profile to other members within the member database based on the other members' physical attractiveness in accordance with the second embodiment.

FIG. 37 illustrates a sample screen through which users can restrict the display of their profile while in a chat room to other members within the member database based on the other members' physical attractiveness in accordance with the second embodiment.

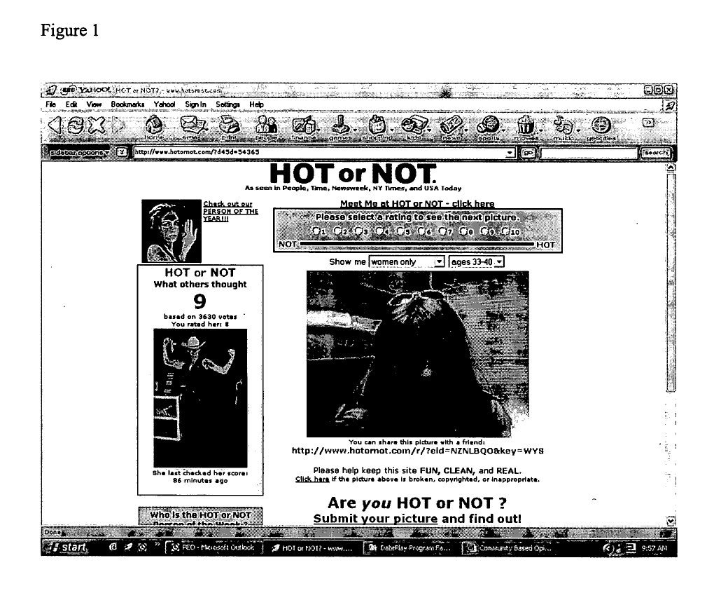

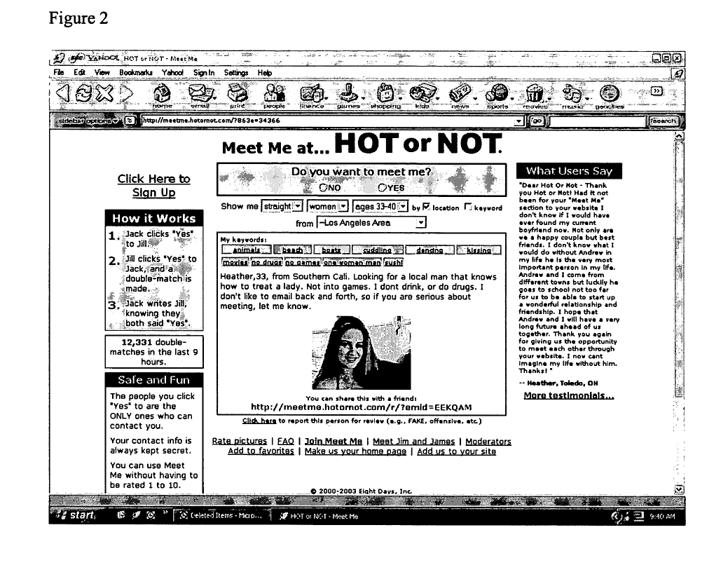

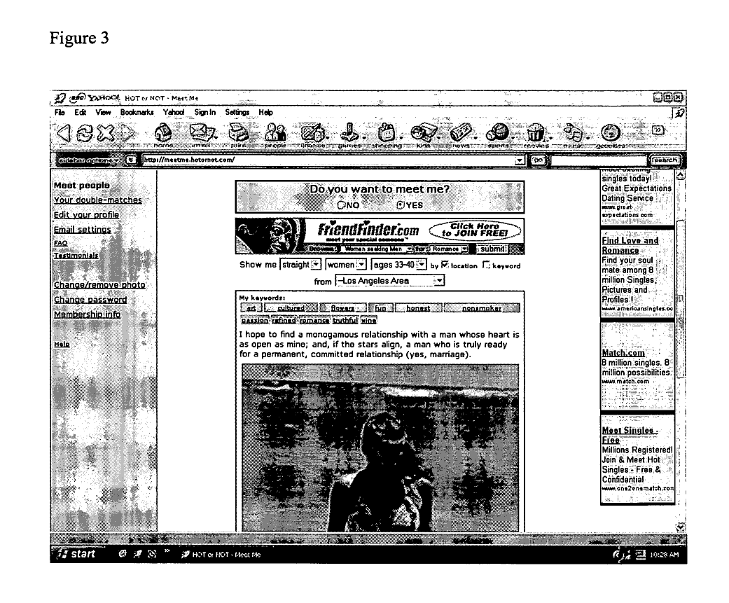

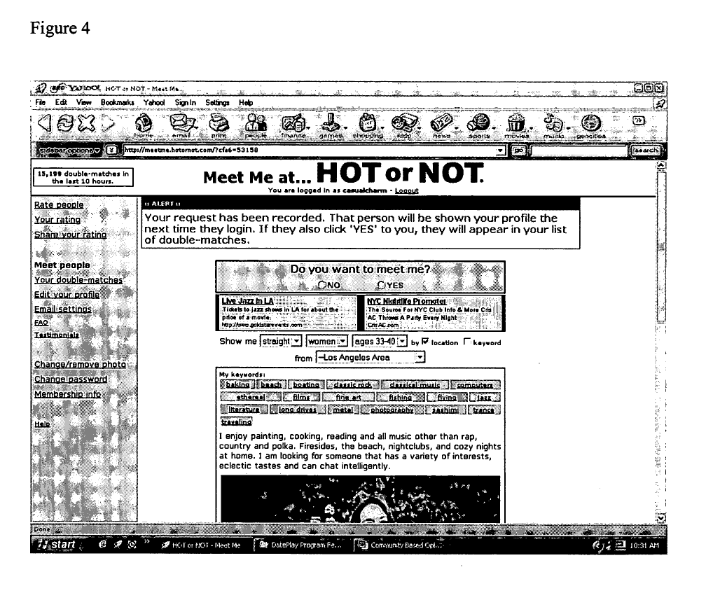

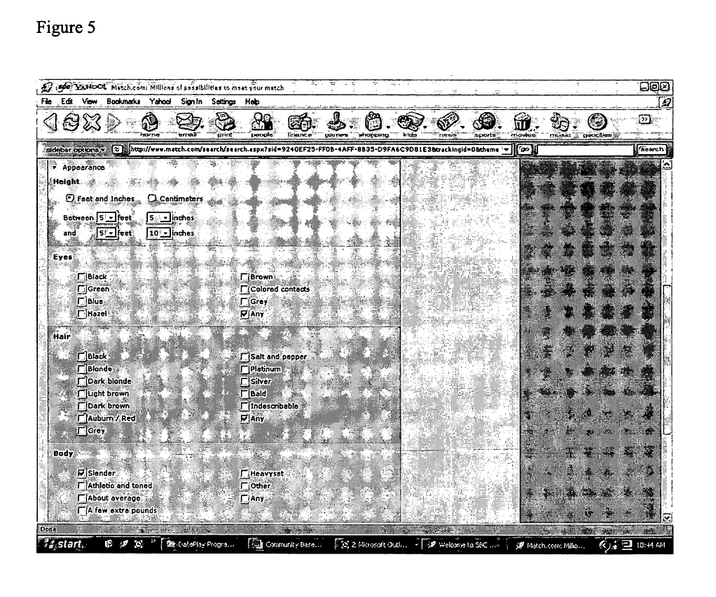

### DETAILED DESCRIPTION OF ILLUSTRATIVE EMBODIMENTS

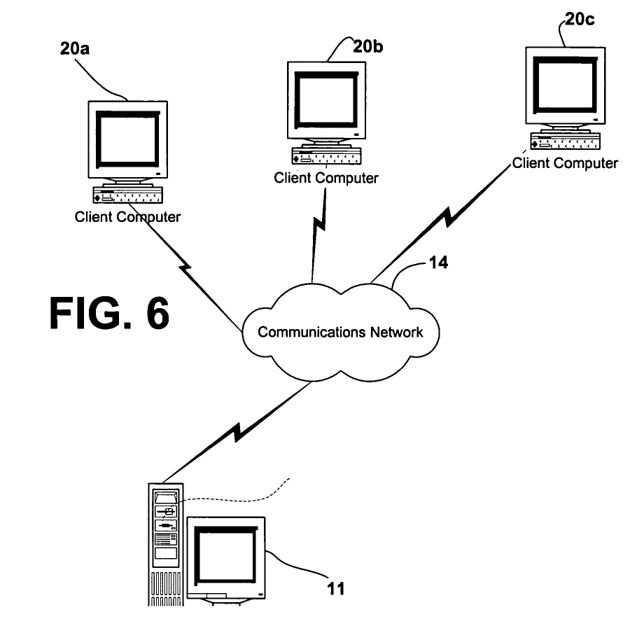

A detailed description of an exemplary embodiment of the present invention will now be described with reference to FIGS. 6-37. Although this description provides detailed examples of possible implementations of the present invention, it should be noted that these details are intended to be exemplary and in no way delimit the scope of the invention.

System Overview

FIG. 6 shows a high level overview of a network environment in which aspects of the present invention may be implemented. One or more client stations 20a, 20b, 20c, can be coupled via the Public Switched Telephone Network (PSTN) to an Internet Access Provider (IAP) station. The IAP station in turn, is connected in the “Internet” 14 (i., the well known globally interconnected network of host servers, including World Wide Web servers 11).

According to conventional practice, an IAP subscriber at client station 20 dials a modem at the IAP station, which typically includes a rack of modems (i.e., modulator-demodulators) which can then accept multiple incoming calls simultaneously. The call is completed over the PSTN by a switching station at the central office of a telephone service provider. Once the call to the IAP station is completed, the client station 20 is connected in the Internet 14, and the client station 20 can issue data requests to web sites on web servers 11 using the IAP station as a conduit. In an alternative embodiment, the client station 20 maintains a permanent connection to the Internet 14 using a network or similar interface, in which case dialing in is not required.

Thus, while connected in the Internet, the IAP subscriber may access an information database (i.e., the Internet 14) spanning the globe much as if such information were stored locally at the subscriber's client station 20a, 20b, 20c.

A number of protocols are used to exchange commands and data between computers connected to the Internet. The protocols include the File Transfer Protocol (FTP), the Hyper Text Transfer Protocol (HTTP), the Simple Mail Transfer Protocol (SMTP), and the Gopher document protocol. The HTTP protocol is used to access data on the World Wide Web, often referred to as “the Web.” The Web is an information service on the Internet providing documents and links between documents. It is made up of numerous Web sites located around the world that maintain and distribute electronic documents. A Web site may use one or more Web server 11 computers that store and distribute documents in a number of formats, including the Hyper Text Markup Language (HTML). An HTML document contains text and metadata (commands providing formatting information), as well as embedded links that reference other data or documents. The referenced documents may represent text, graphics, or video. The presently described embodiment is thus described below with reference to an IAP subscriber or user having access to a web server 11 having HTML documents representing web pages. The web pages together facilitate Web based dating services in accordance with an embodiment of the present invention.

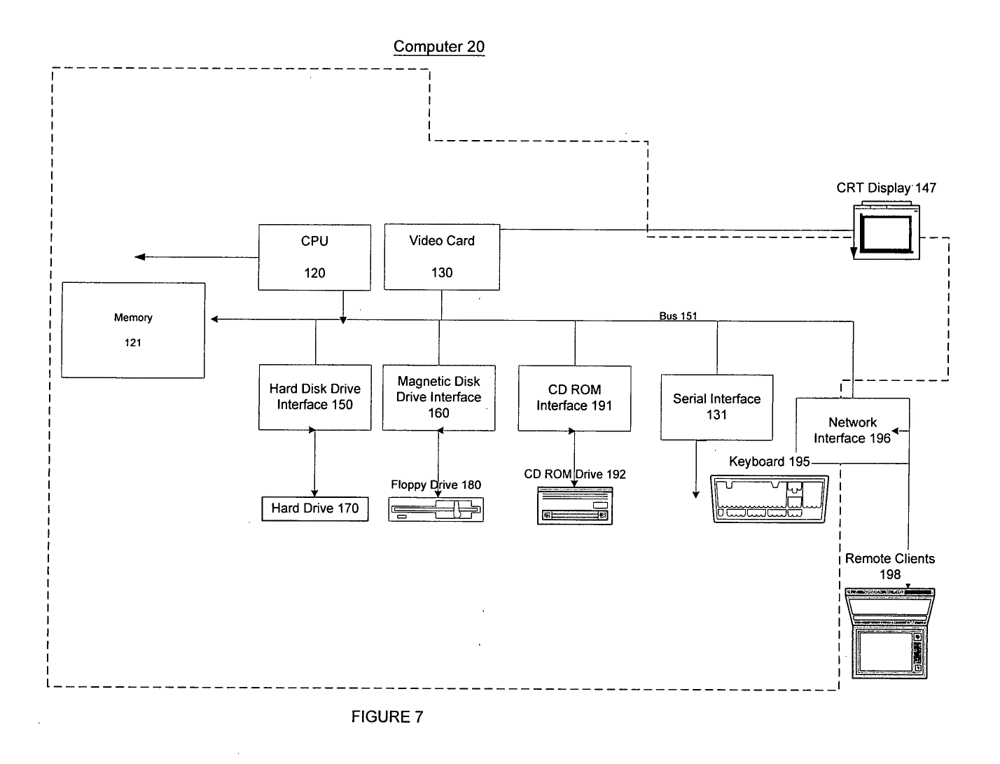

FIG. 7 illustrates a block diagram depicting components of the client stations 20 shown in FIG. 6 in greater detail. In particular, the client station 20 in FIG. 6 includes conventional computer hardware components including a Central Processing Unit (“CPU”) 120, a system memory 121, and a system bus 151 that couples the system memory 121 to CPU 120 and other computer system 20 components. The system memory 121 typically includes read only memory (ROM), random access memory (RAM) or other conventional known memory types. Instructions comprising application program modules, including an operating system, are typically stored in and retrieved from memory 121 by CPU 120, which executes these instructions. In particular, in the presently described embodiment, a user's client incorporates application program modules that include a browser element. A Web Browser is a client application or an integrated operating system utility that communicates with server computers via FTP, HTTP and Gopher protocols. In the presently described embodiment, a Web browser functions to request and receive web pages and data from a web server 11 storing an Internet Dating web site service and to graphically present the web pages to a user on a display device.

The display device 147 is also coupled to the system bus 151 via a video graphics adaptor card 130. The display device 147, which may be a CRT monitor, LCD terminal or other display, includes a screen for the display of information visible to the user.

The user controls the web browser by entering commands and other input into the computer 20 via input devices such as a keyboard 195, mouse, scanner or other input device. In the exemplary computer system illustrated, the keyboard 195 is coupled to CPU 120 via a serial port 131 coupled to system bus 151.

The present invention includes an Internet based dating web site providing a variety of services useful to those individuals seeking a friend or mate. In the presently described embodiment this site consists of web pages comprising HTML data requested and graphically interpreted by the user's web browser.

Dating Web Site

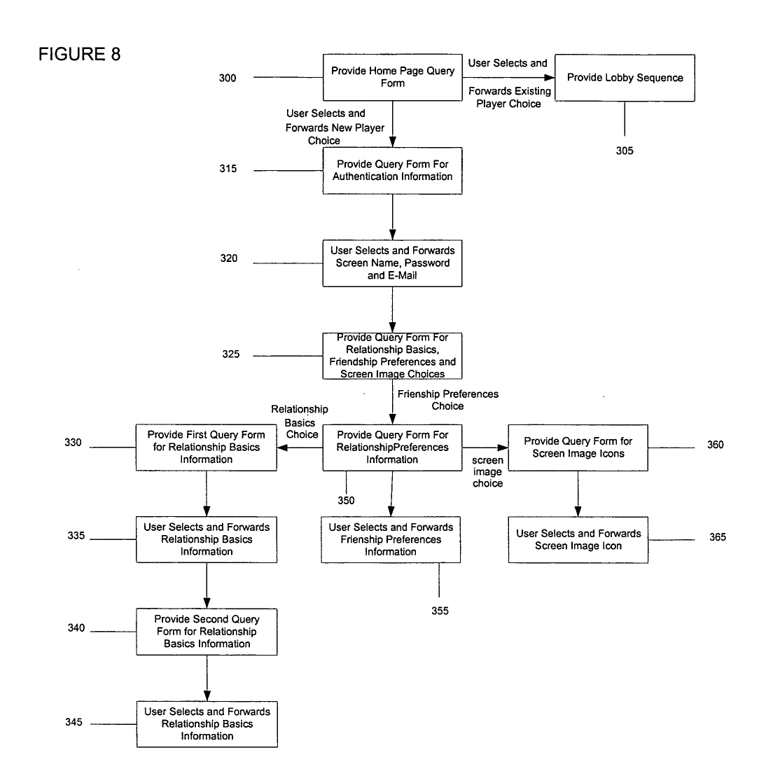

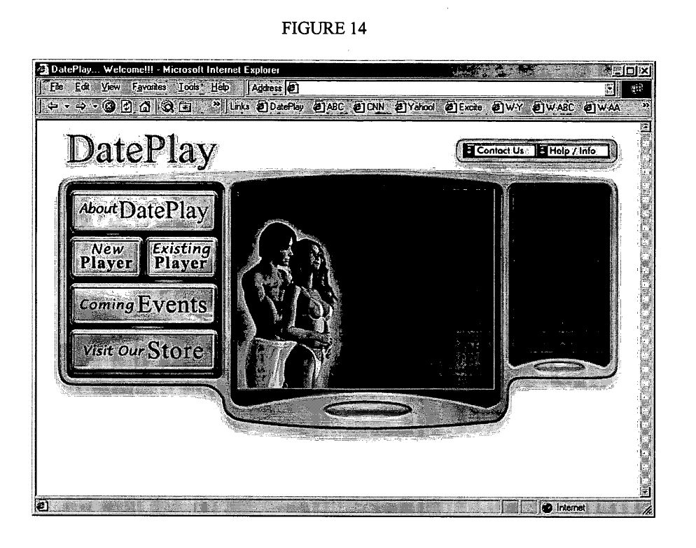

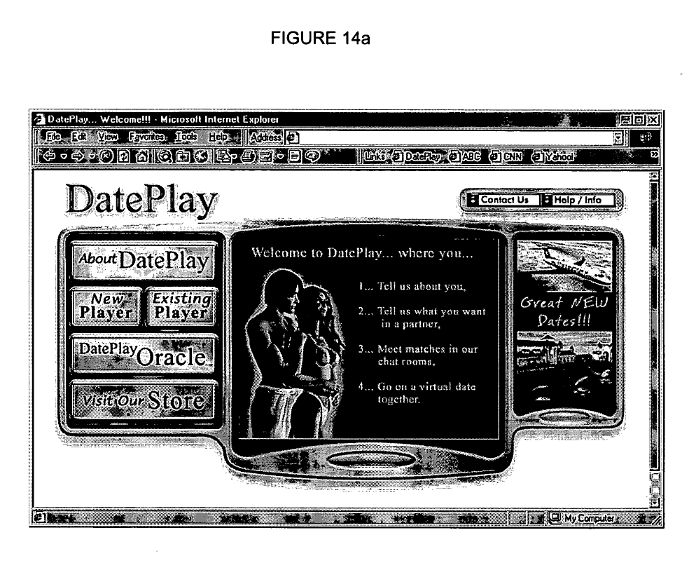

FIG. 8 illustrates a high level flow chart depicting a process of new subscriber registration at a dating web site in accordance with the invention, including profile subscriber creation. In particular, in Step 300 and in accordance with conventional processes, upon a user's keying of a URL (or selection of a displayed web page hyperlink), the client station 20 browser forwards an http request for a the Internet Dating service home page to the site provider's web server 11 or to a web server 11 hosting the site provider's site. In response, the web server software causes the corresponding home page consisting of HTML data to be returned to the client station 20. The web page returned includes an image map having image-based parts with corresponding hyperlinks allowing the user to specify whether he/she is new to the site or is already a registered subscriber. For example, FIG. 14 depicts an exemplary “home page” web page interface with “new player” and “existing player” selections as displayed on display device 147. FIG. 14a depicts a similar “home” page in accordance with an alternative embodiment.

Thus, in response to the home page with image maps, the user selects either the “new player” choice or “existing player” choice and causes the browser element to forward the choice to the site provider's web server 11. The web server 11, in turn, receives the user request and extracts data corresponding to the user's selected choice.

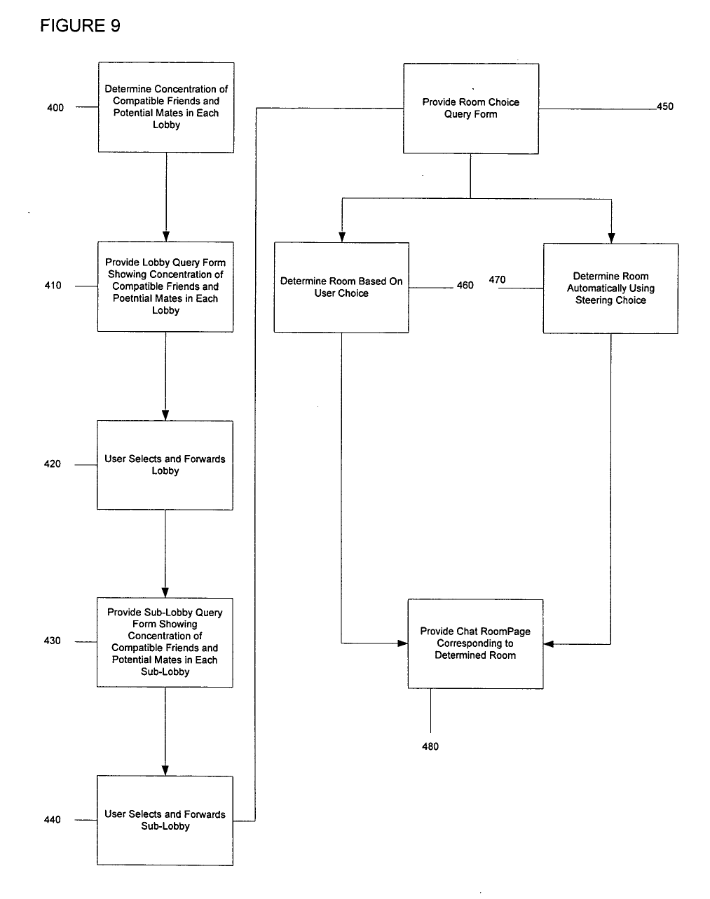

In Step 305, if the user has selected the “existing player” choice, then the web server 11 returns a log-on screen allowing the user to authenticate himself/herself as an existing subscriber. Once authentication information is provided, a web page is returned initiating a process, in accordance with an embodiment of the present invention, of user navigation to a desirable chat room environment having participants compatible with the user. This process is described in greater detail below with reference to FIG. 9.

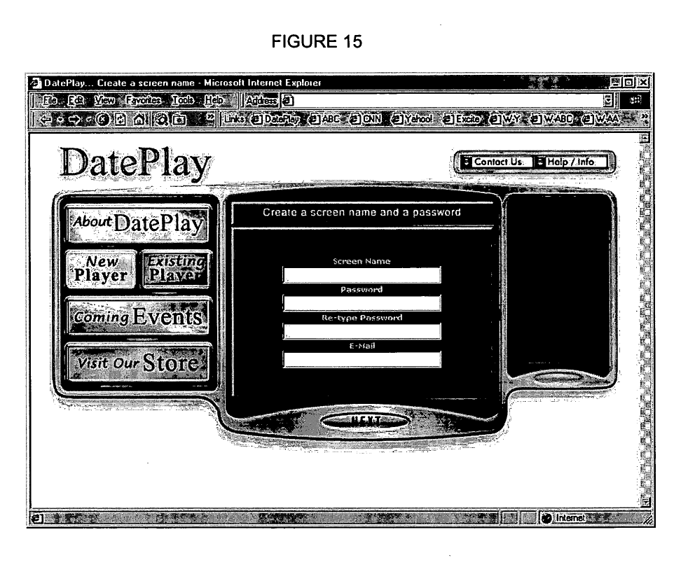

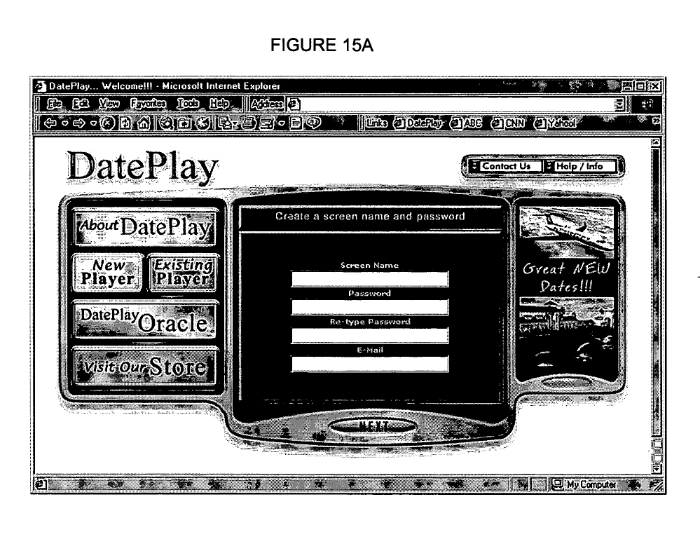

If, however, the user selected the “new player” button, then in step 315 of FIG. 8 the web server 11 returns a query form page initiating a process of subscriber profile creation in accordance with an embodiment of the present invention. In particular, the web server 11 first returns a query form page allowing entry of authentication information corresponding to the user in a user profile stored at the web server 11 and maintained by the site provider. For example, FIG. 15 depicts an exemplary query form page interface allowing entry of a screen name, password, re-entry of password and electronic mail address information. FIG. 15a depicts a similar query from page in accordance with an alternative embodiment.

The screen name corresponds to a name the user will go by as a chat participant when using the virtual chat services provided by the web site. The screen names need not correspond to the user's actual name and thus allows for some anonymity during chat participation. The password will allow the user to log onto the web site as an existing subscriber in future access sessions, and will also allow the web server 11 to identify and retrieve the user's profile thus obviating the need for profile re-creation prior to each access session. The password re-entry field allows confirmation of the password typed in by the user. Finally, the electronic mail address field allows entry of the user's electronic mail address. This e-mail information allows the site provider to communicate with subscribers (for example, to provide a forgotten password or to provide dating, vacation or singles related special offers to the user).

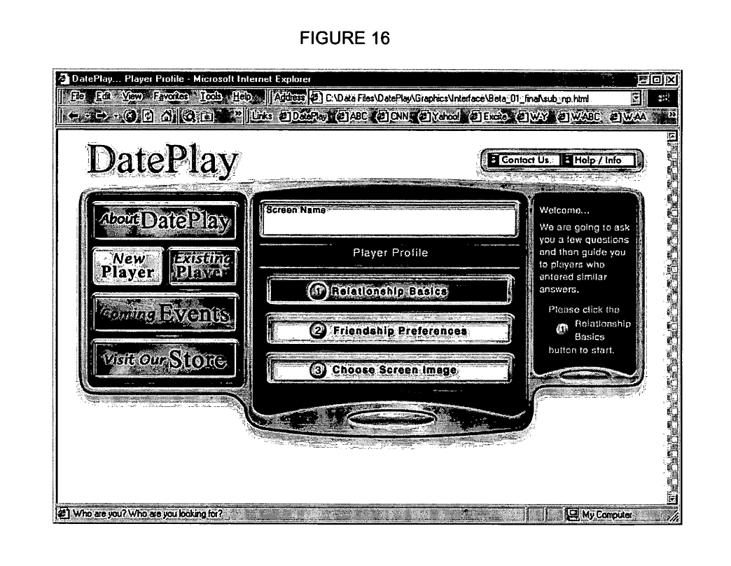

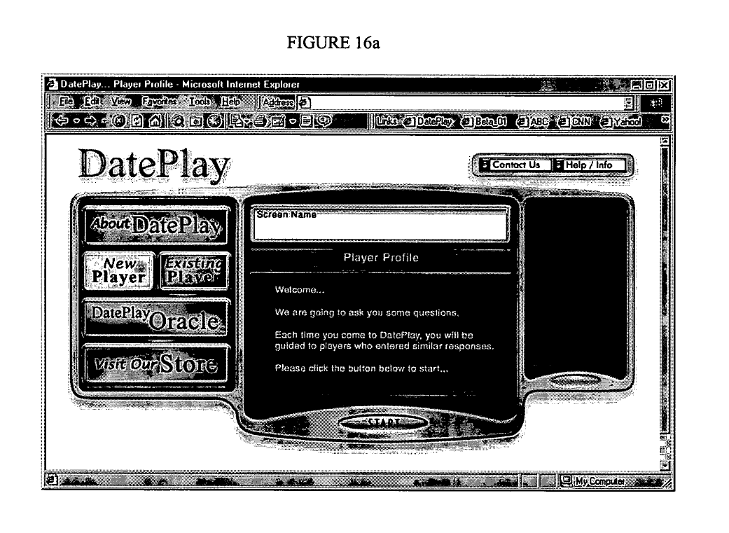

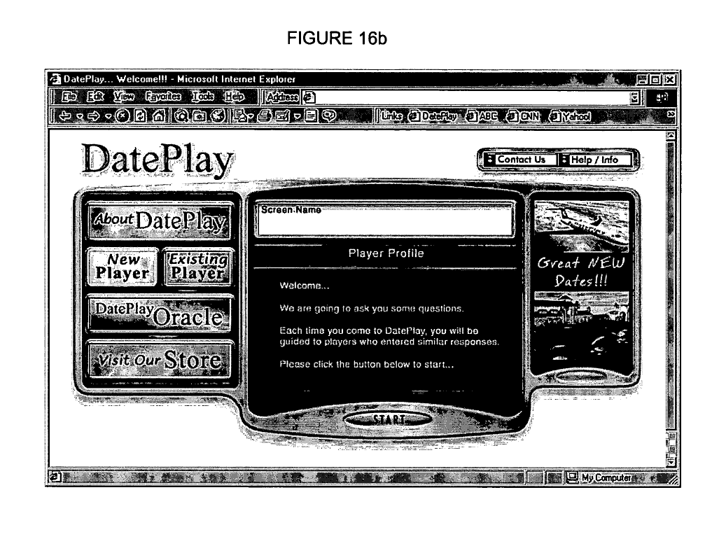

Thus, in Step 320, the user specifies screen name, password and electronic mail information and causes the browser element to forward the selections to the site provider's web server 11. The web server 11, in turn, receives the user request and extracts and stores data corresponding to the user's selected choices in a user profile corresponding to the user. Further, at step 325, in response the web server 11 returns a query form page initiating a process for completing the subscriber profile. For example, in accordance with alternative embodiments, FIGS. 16a and 16b depict exemplary web page displays that may notify the user that this process has begun. However, in the presently described embodiment, the user has a choice of completing selected portions of a player profile. In that case, the player profile completion process is initiated with a screen such as FIG. 16, which depicts an exemplary web page with image maps with conventional displayed “buttons.” The exemplary web page of FIG. 16 allows entry of a relationship basics choice, a friendship preferences choice or a screen image icon choice. That is, the displayed buttons correspond to “relationship basics,” “friendship preferences,” or “screen image icon” choices. The “relationship basics” information selection initiates a process allowing the user to specify those qualities he or she desires in a mate. The “friendship preferences” choice initiates a process allowing the user to specify those qualities he or she desires in a friend. Finally, the “screen image icon” choice allows a user to specify a graphics image corresponding to the user that is displayed for the benefit of other participants whenever the user participates in chat sessions facilitated at the web site. The screen image icon may be an actual picture of the user or may be chosen from a predefined set of icons maintained by the site provider.

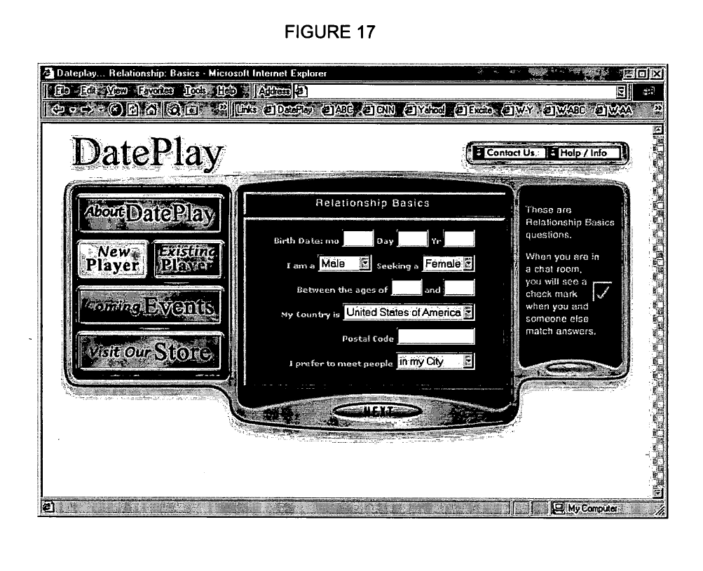

In Step 330, if the user has selected the “relationship basics” choice, then the web server 11 returns a web page query form allowing entry of a first set of information specifying the qualities the user desires in a mate. For example, FIG. 17 depicts an exemplary web page interface allowing user entry of a first set of “relationship basics” information. Here, the “seeking” field allows entry a gender for the desirable mate. The “I prefer to meet people” field allows the user to specify that he wishes to date only individuals in his city, region or country, as the case may be. The web server 11 can use this information in conjunction with information specified in the “postal code” and “county” fields to determine the geographic area within which the user desires to find a mate. The desired age range field allows the user to specify the age range of the user's desired mate.

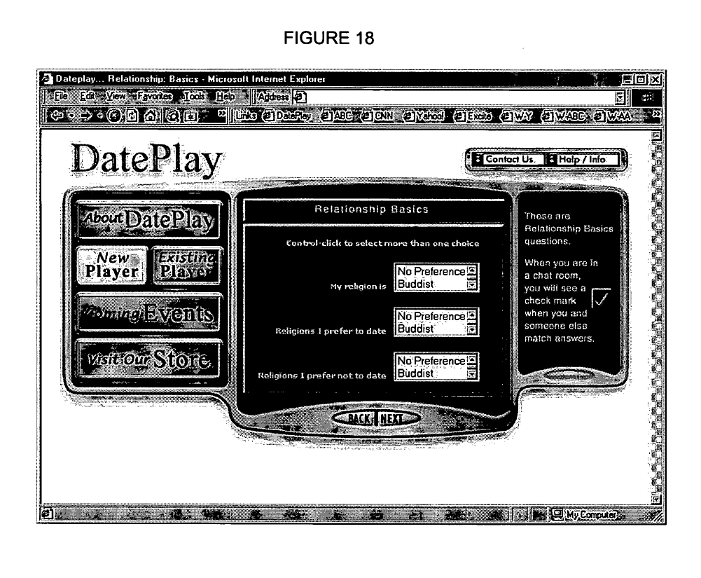

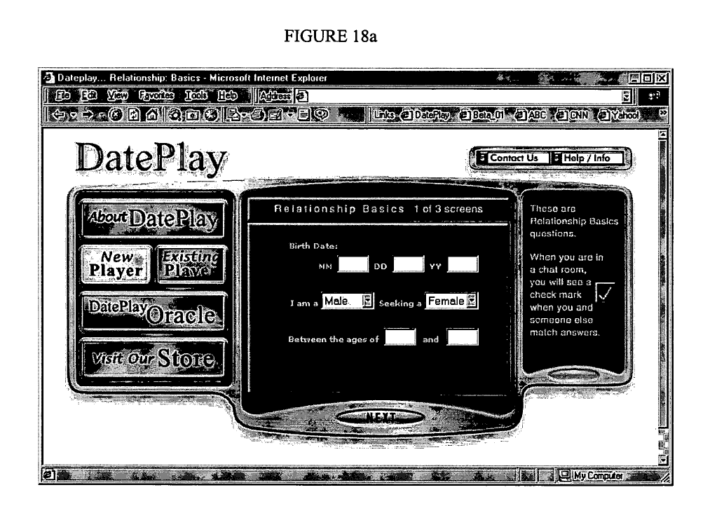

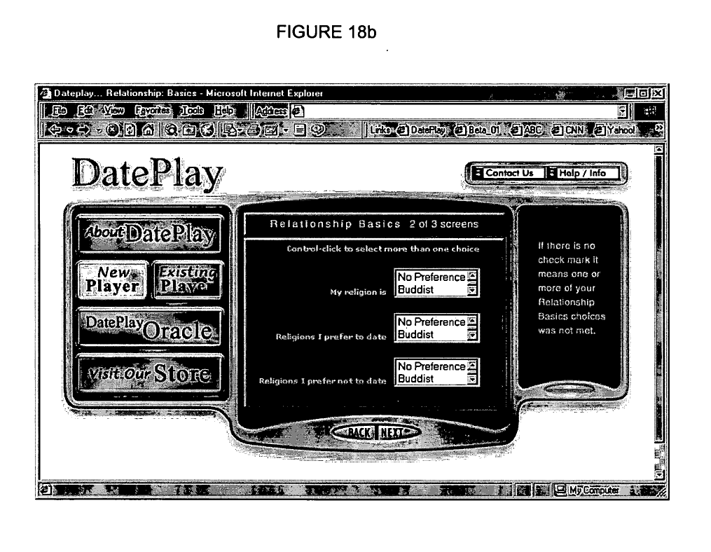

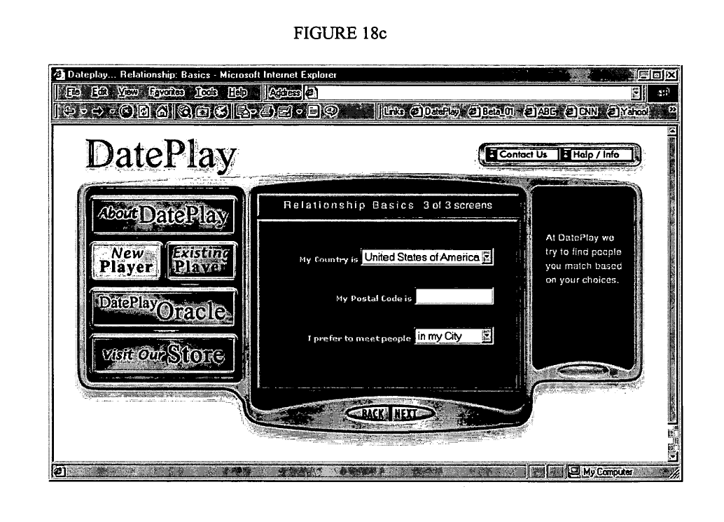

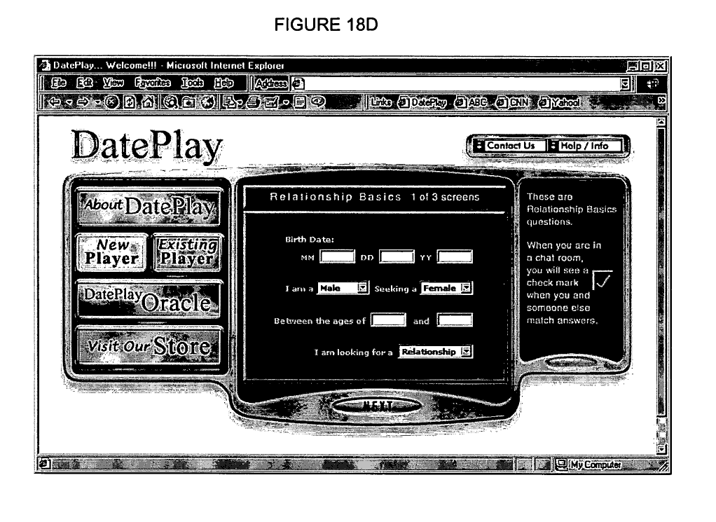

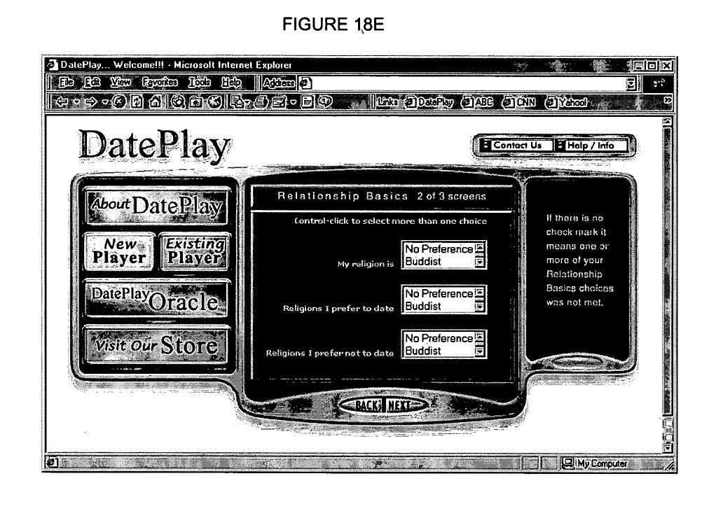

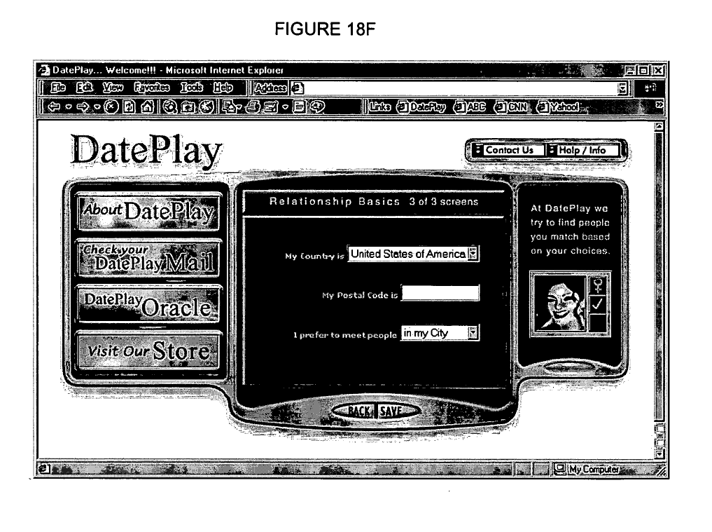

Thus, in Step 335, the user specifies user's date of birth, user's gender, mate's desired gender, age criteria for desired mate, user's country, and geographic criteria for desired mate information and causes the browser element to forward the selections to the site provider's web server 11. The web server 11, in turn, receives the user request and extracts and stores data corresponding to the user's selected choices in a user profile. Further, in response, in step 340, the web server 11 returns a query form page allowing the entry of still further information specifying the qualities the user desires in a mate. For example, FIG. 18 depicts an exemplary web page interface allowing user entry of a second set of “relationship basics” information. Here, the “religions I prefer to date” field allows entry of a religion(s) for the user's desirable mate. The “religions I prefer not to date” field allows the user to specify that he/she does not wish to date individuals belonging to the specified religions.

Thus, in Step 345, the user specifies information in the “My religion is,” “Religions I prefer to date” and “religions I prefer not to date” fields and causes the browser element to forward the selections to the site provider's web server 11, thus completing the user specification of the relationship basics portion of the profile. Note that in alternative embodiments, the relationship basics may be selected and forwarded to the web server 11 two, four or any other number of screens. For example, in accordance with an alternative embodiment, FIGS. 18a-18c depict screen interfaces for selecting and forwarding the relationship basics information using three screens instead of two. In accordance with yet another alternative embodiment, FIGS. 18d-18f similarly depict three screen interfaces for selecting and forwarding relationship basics information. In this alternative embodiment, the user may also select and forward a relationship type (i.e., friendship or romantic relationship).

Upon receiving the relationship basics information, the web server 11 extracts and stores data corresponding to the user's selected choices in a user profile corresponding to the user. The web server 11 also returns a web the page (as in Step 325) allowing entry of a relationship basics choice, a friendship preferences choice or a screen image icon choice (as exemplified in FIG. 16).

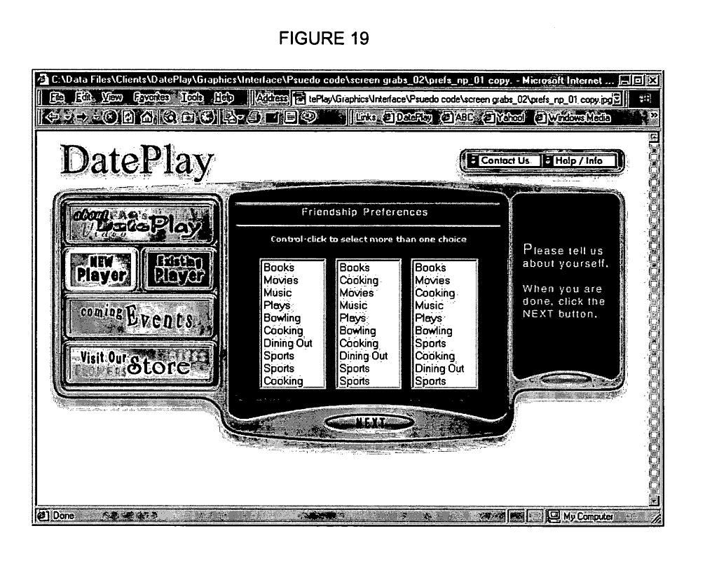

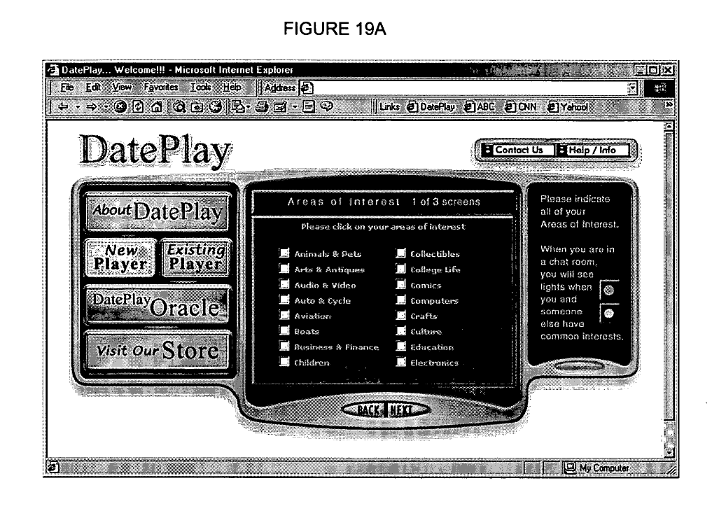

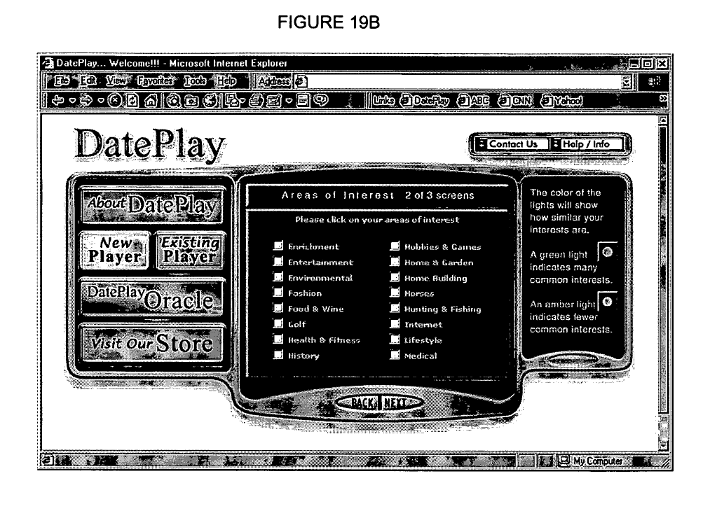

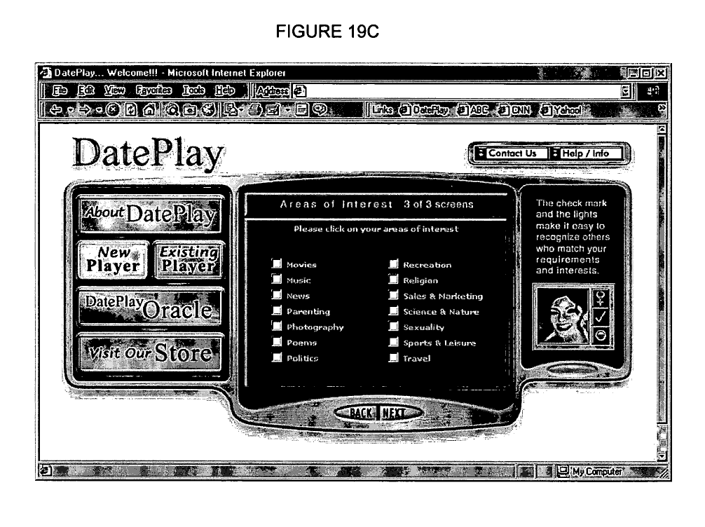

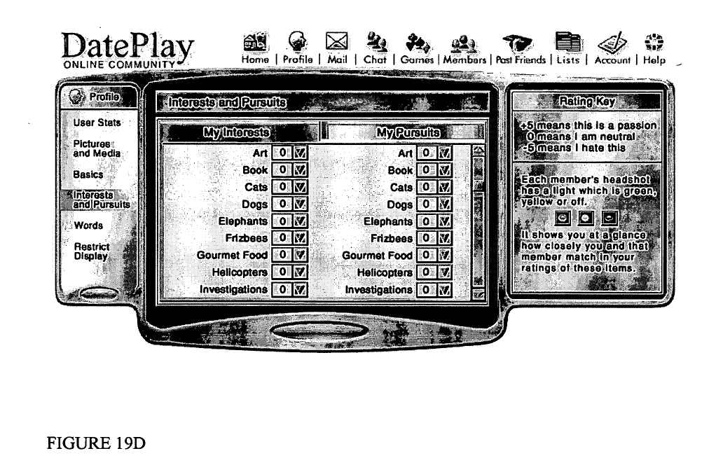

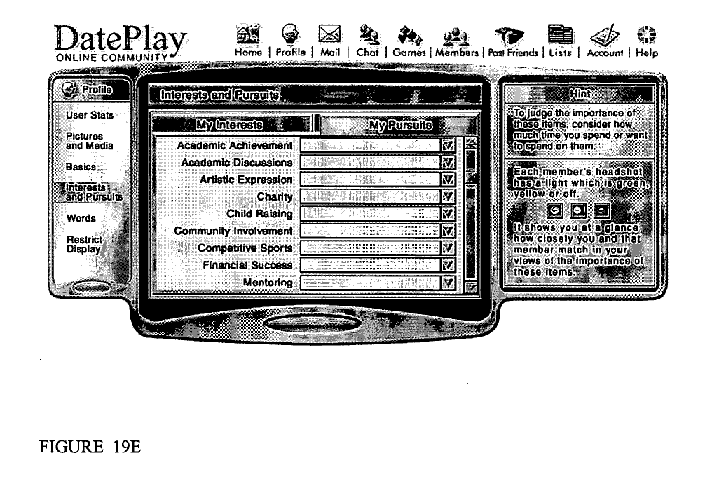

In the presently described example, the user wishes to complete the profile with information relating to the qualities he/she desires in a friend. Thus, when the user has selected the “friendship preferences” choice, in Step 350, the web server 11 returns a web page query form allowing entry of a set of information specifying areas of interest (e.g., books, movies, cooking) to the user. FIG. 19 depicts an exemplar of such a web page interface. Here, each of three menus allow specification of multiple areas of interest that can be later compared with areas of interest of other site participants to determine compatibility with the user. Note that in the presently described embodiment the items selected in the second and third columns displayed in FIG. 19 will be different than those selected in the first column. Note also that in alternative embodiments, the area of interest information may be selected and forwarded to the web server 11 with two, three or any other number of screens. For example, FIGS. 19a-19c depict screen interfaces for selecting and forwarding the are of interest information using three screens with check boxes instead of one screen with pull down menus.

In accordance with a presently preferred embodiment of the invention, an additional scheme for interest matching is provided whereby interest-based compatibility is assessed as a function of an indication by members concerning not just a true-false response set but the degree of subscription or non-subscription a member has to each interest. That is, members are provided the opportunity to indicate on a scale of −5 to +5 the degree to which they are interested or disinterested in a given item or interest area (example: Art). The results are then accumulated to establish the degree of interest-based alignment among members. FIGS. 19d and 19e depict screen interfaces for eliciting such interest-based compatibility information. As will be explained in more detail below, the compatibility checking software may then assess the degree of common interest between respective members based on the total number of matching interests as well as the degree of alignment among those matching interests, thereby providing more a significantly more accurate and nuanced compatibility assessment.

Once the user specifies the area of interest information in Step 355 the browser element then forwards the selections to the site provider's web server 11. The web server 11, in turn, receives the user request and extracts and stores data corresponding to the user's selected choices in a user profile corresponding to the user. The web server 11 also returns a web the page (again as in Step 325) allowing entry of a relationship basics choice, a friendship preferences choice or a screen image icon choice (as exemplified in FIG. 16).

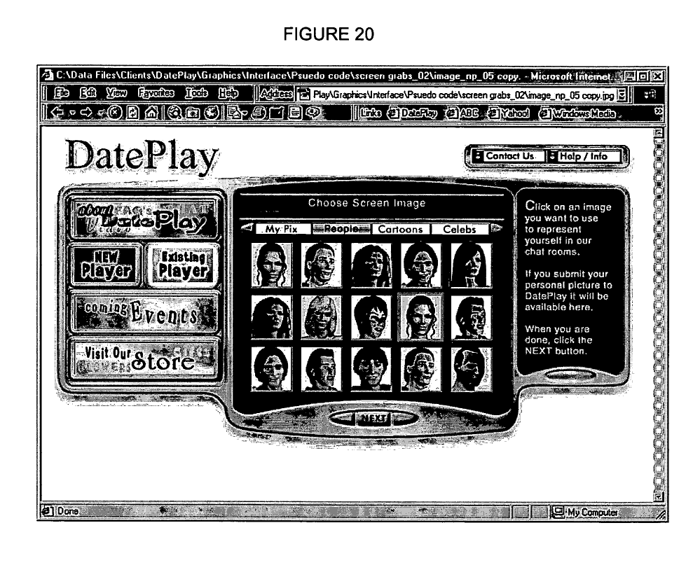

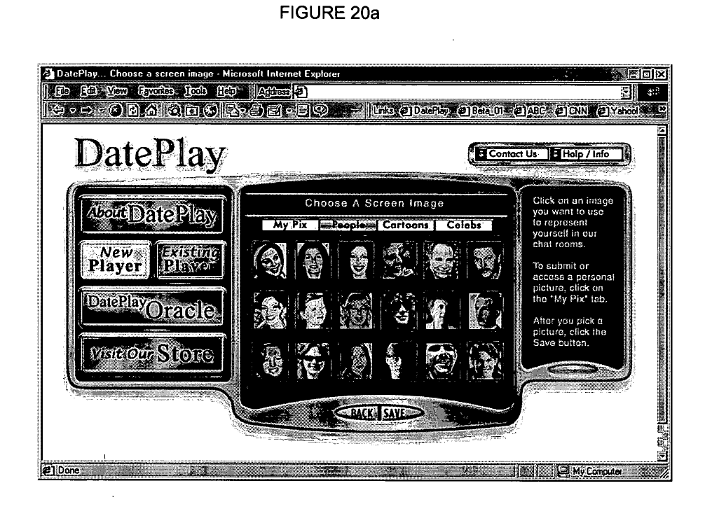

In the presently described example, the user wishes to complete the profile with information relating to the screen icon he/she wishes to present to other participants during chat sessions. Thus, when the user has selected the “screen image” choice, in Step 360, the web server 11 returns a web page query form allowing entry of a set of information corresponding to a screen icon representing the users. FIG. 20 depicts an exemplar of such a web page interface. The interface provides a series of predefined screen icons from which the user may choose. Thus, in Step 365, the user specifies an icon and selects the “next button” causing the browser element to forward the selection to the site provider's web server 11. In an alternative embodiment, the user creates a digital photo of him or herself (e.g., using conventional scanning processes) and forward the picture to the site provider (e.g., via electronic mail or via a special screen interface). For example, FIG. 20a depicts a web page interface allowing a choice among screen image icons forwarded to the site provider earlier.

Once the user's relationship basics, friendship preferences and screen image is specified, the user profile is complete and the user can log on as an existing subscriber of the site in future site access sessions. Further, as the option of changing aspects of his or her corresponding profile by aspects of the profile. For example, upon logging on as an existing subscriber the user may choose the “relationship basics,” “friendship preferences,” or “screen image” choices, as in step 325 of FIG. 8, to re-define those respective aspects of the profile. Each time the profile is redefined in this manner an updated version of the profile is stored on the web server 11 or in a database associated with the web server 11 maintained by the site provider.

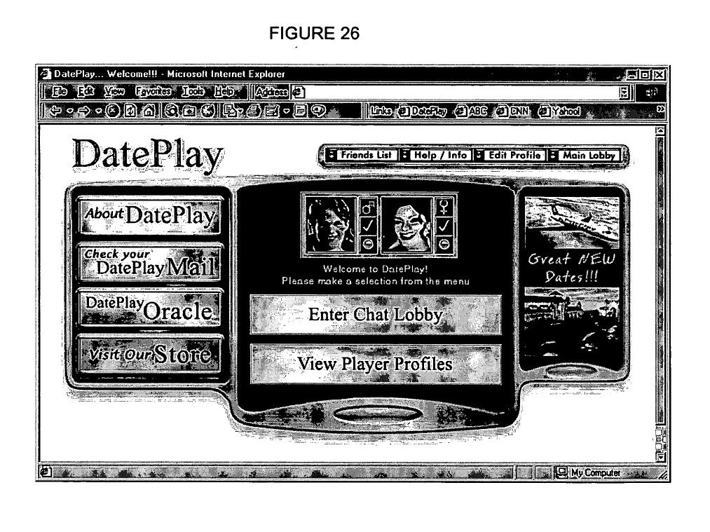

In addition, upon logging on as an existing subscriber the user can take advantage of the relationship facilitation services provided by the dating related web site. For example, in the presently described embodiment, upon logging in as an existing user, the user is presented with a screen such as that depicted in FIG. 26 allowing the user to take advantage of on line chat room and other services facilitated by the dating related web site. If the user selects the “View Player Profile” option, the user is directed to a screen that enables the user to view the information assembled about a player in the corresponding player profile. In that event, the user can send e-mails to such other players that seem interesting.

If the user selects the “Enter Chat Room” button, the user is presented with the ability to arrive at a desired chat room environment by navigating to a chat room with participants having relative compatibility with the user. This navigation is made easier by the hierarchical organizations of chat rooms featured at the dating related web site. In particular, in the presently described embodiment, the chat rooms are organized into sub-lobbies, which in turn are organized into lobbies. In an advantageous aspect of the present invention, the lobbies each correspond to a broad category of conversation topic characterizing the subject of the chat in each chat room within the lobby. Further, each room within a sub-lobby features sub-topics of conversation falling within the broad topic associated with the lobby within which the sub-lobby is organized. A user can thus find a chat room featuring an optimal chat topic by selecting a broad topic of interest (e.g., sports) on the lobby level, a narrower sub-topic of interest falling within the broad topic (e.g., hockey) on the sub-lobby level, and then a chat room within the selected sub-lobby.

In another advantageous aspect of the present invention, the web-page interfaces corresponding to the lobby, sub-lobby and chat room selections provide feedback indicating the concentration of compatible participants in each lobby, sub-lobby or chat room, as the case may be. In this way, the user's selection of chat rooms may be based not only on a favorable topic of conversation featured at the chat room, but also on the likelihood that a greater percentage of participants are compatible with the user. For example, FIG. 9 depicts a process of subscriber navigation to a desirable chat room in accordance with an embodiment of the present invention. The process described assumes the user has already logged on as an existing subscriber and intends to participate in a chat.

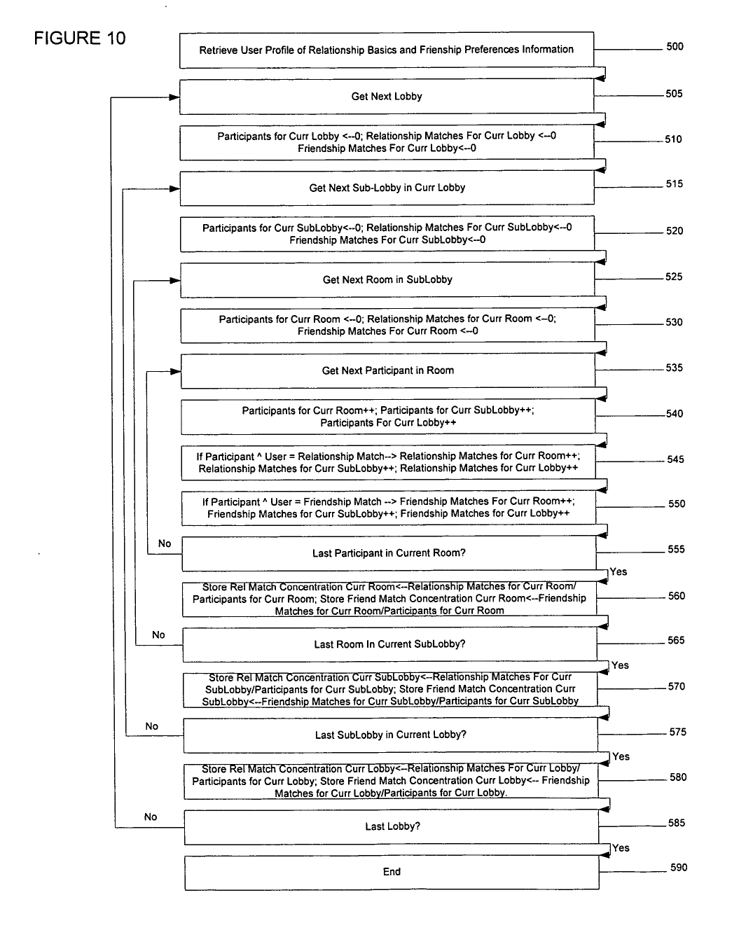

Before providing the lobby/sub-lobby/room sequence, in order to provide the compatibility and screening feedback discussed above, the web server 11 (or an associated server) in Step 400 determines the concentration of compatible participants in each room, sub-lobby and lobby within which a chat is taking place. This step depicted in greater detail in FIG. 10 in accordance with an embodiment of the present invention. In particular, in Step 500 of FIG. 10, the web server 11 first retrieves the user's profile from storage in a database. In the presently described embodiment, the user's profile is filled completely as describe above in connection with FIG. 8, though in other embodiments the profile may be partially filled with only relationship related information or only friendship related information.

Next, in Step 505, the web server 11 retrieves a first lobby from a stored set of lobbies (e.g., a “sports” lobby). In particular, data corresponding to the set of lobbies is preferably stored in a relational database configured with associations or links specifying the hierarchical relationship between lobbies, sub-lobbies within lobbies and rooms within sub-lobbies as described above. Once the first lobby is retrieved (e.g., by retrieval of a lobby identifier), in Step 510, variables having information corresponding to this particular lobby are initialized. In particular, “Participants,” “Relationship Matches,” and “Friendship Matches” variables are set to zero.

Next in Step 515, the first sub-lobby within the retrieved lobby having an active chat room is retrieved from the relational database of lobby, sub-lobby and chat room information. As with the lobby, variables having information corresponding to this particular sub-lobby are then initialized in Step 520. That is, “Participants,” “Relationship Matches” and “Friendship Matches” variables are set to zero.

Next in Step 525, the web server 11 retrieves the first active chat room within the retrieved sub-lobby from the relational database of lobby, sub-lobby and chat room information. To perform this task, the web server 11 also checks which chat rooms within the current sub-lobby are active. As with the sub-lobby, variables having information corresponding to this particular room are then initialized in Step 530. That is, “Participants,” “Relationship Matches” and “Friendship Matches” variables are set to zero.

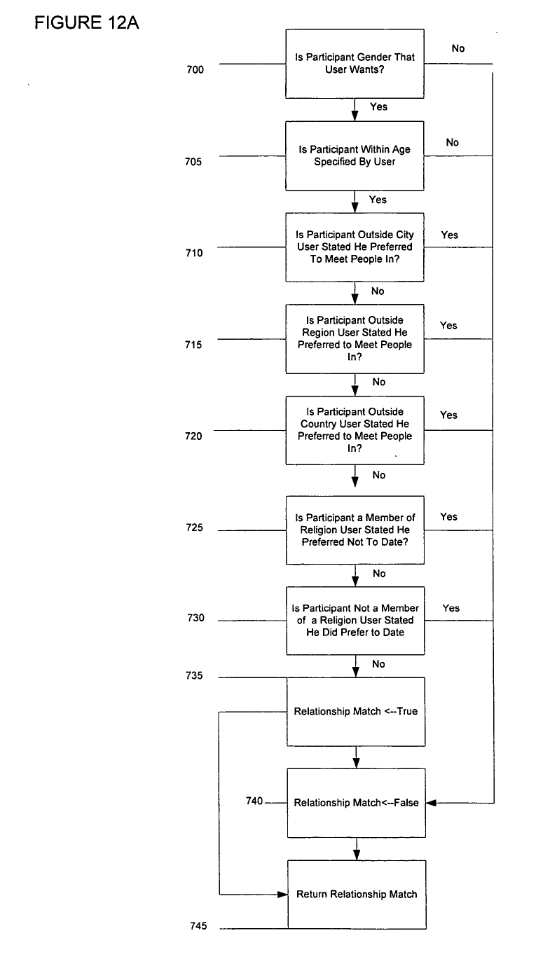

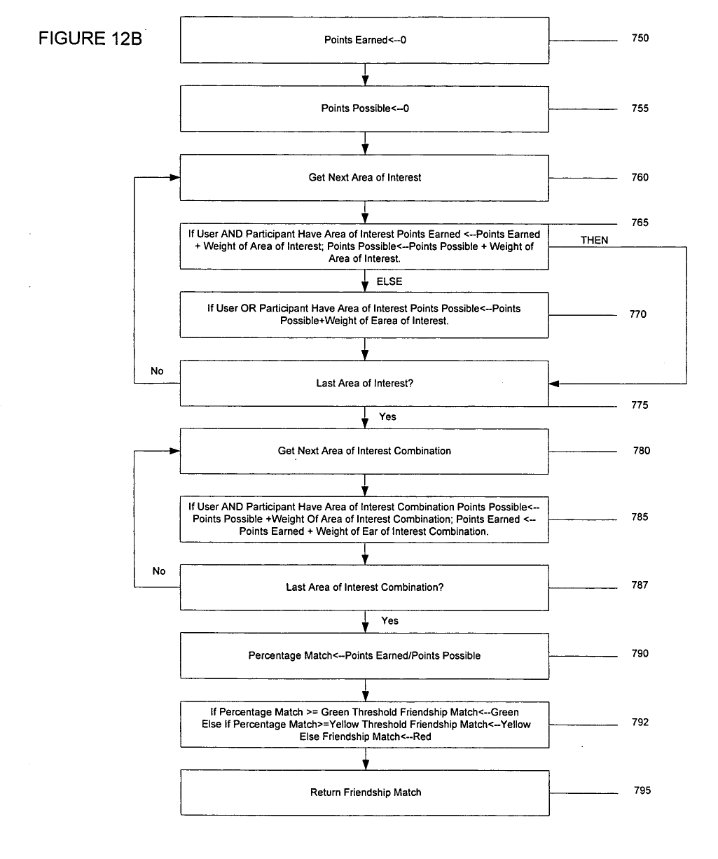

Next in Step 535, the first participant within the retrieved chat room is retrieved by checking for the participants active in the room. At the same time, the “Participants” variables for the current lobby, sub-lobby, and room are incremented by one in Step 540 and the participant's profile stored at the web server 11 (or associated database) is retrieved for comparison with user's. In particular, in Step 545 the web server 11 compares the participant's profile to the user's to determine whether there is a relationship match between the two. An exemplary process for determining whether there is a relationship match between two subscribers of the dating-related web site in accordance with an embodiment of the present invention is described more fully in connection with FIG. 12a below. If such a procedure returns a relationship match, then the “Relationship Matches” variables for the current lobby, sub-lobby and room are also incremented by one. Similarly, in Step 550 the web server 11 compares the participant's profile to the user's to determine the degree to which there is a friendship match between the two. If such a procedure returns a sufficient degree friendship compatibility, then the “Friendship Matches” variables for the current lobby, sub-lobby and room are also incremented by one. An exemplary process for determining the degree of friendship compatibility between two subscribers of the dating-related web site, as well as the threshold degree of compatibility necessary to be deemed a friendship match, in accordance with an embodiment of the present invention, is described more fully in connection with FIG. 12b below.

In Step 555, the web server 11 determines whether the current participant is the last in the currently considered chat room. If not then the next participant in the room is retrieved along with a corresponding profile and the process of Steps 540-555 is repeated. In this way the process is repeated for each participant in the room and thus eventually yields the number of participants in the room, the number of such participants that are relationship matches and the number of such participants that are friendship matches. Thus, once the web server 11 determines during an iteration of Step 555 that there are no more participants, in Step 560 the web server determines the concentration of relationship matches and friendship matches in the room processed. That is, a “Relationship Match Concentration” variable for the current room is set to the number of relationship matches over the number of participants and is stored for future retrieval at the web server 11 or an associated database. Similarly, a “Friendship Match Concentration” variable for the current room is set to the number of friendship matches over the number of participants in the room and is stored.

Next, in Step 565, the web server 11 determines whether the current room is the last in the currently considered sub-lobby. If not then the next room in the sub-lobby is retrieved and the process of Steps 530-565 is repeated. In this way the process is repeated for each room in the currently considered sub-lobby. This ensures that relationship match and friendship match concentration data for each room in the sub-lobby is stored and also eventually yields the number of participants in the sub-lobby, the number of such participants that are relationship matches and the number of such participants that are friendship matches. Thus, once the web server 11 determines during an iteration of Step 565 that there are no more rooms in the sub-lobby, in Step 570, the web server can determine the concentration of relationship matches and friendship matches in the sub-lobby processed. That is, a “Relationship Match Concentration” variable for the current sub-lobby is set to the number of relationship matches in the sub-lobby over the number of participants in the sub-lobby and is stored for future retrieval at the web server 11 or an associated database. Similarly, a “Friendship Match Concentration” variable for the current sub-lobby is set to the number of friendship matches for the current sub-lobby over the number of participants in the current sub-lobby and is stored.

Next, in Step 575, the web server 11 determines whether the current sub-lobby is the last in the currently considered lobby. If not then the next sub-lobby in the current lobby is retrieved and the process of Steps 520-575 is repeated. In this way the process is repeated for each sub-lobby of rooms in the currently considered lobby. This ensures that relationship match and friendship match concentration data for each room in each sub-lobby in the currently considered lobby is stored and also eventually yields the number of participants in the current lobby, the number of such participants that are relationship matches and the number of such participants that are friendship matches. Thus, once the web server 11 determines during an iteration of Step 575 that there are no more sub-lobbies in the current lobby, in Step 580, the web server can determine the concentration of relationship matches and friendship matches in the lobby processed. That is, a “Relationship Match Concentration” variable for the current lobby is set to the number of relationship matches in the lobby over the number of participants in the lobby and is stored for future retrieval at the web server 11 or an associated database. Similarly, a “Friendship Match Concentration” variable for the current lobby is set to the number of friendship matches for the current lobby over the number of participants in the current lobby and is stored.

Finally, in Step 585, the web server 11 determines whether the current lobby is the last. If not then the next lobby is retrieved from the database of lobby/sub-lobby/room information the process of Steps 510-585 is repeated. In this way the process is repeated for each lobby of sub-lobbies having active chat rooms. This ensures that relationship match and friendship match concentration data for each room and sub-lobby of rooms in each lobby, as well as for each lobby, is eventually stored, completing the process. Once the server 11 determines during an iteration of Step 585 that there are no more lobbies, the process ends in Step 590.

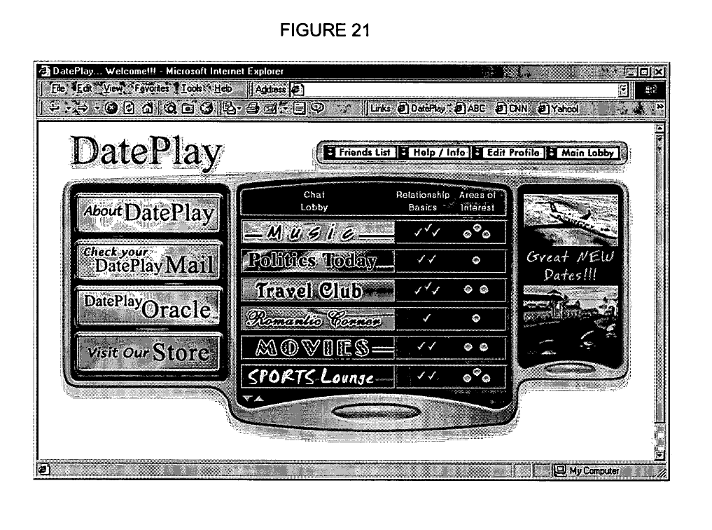

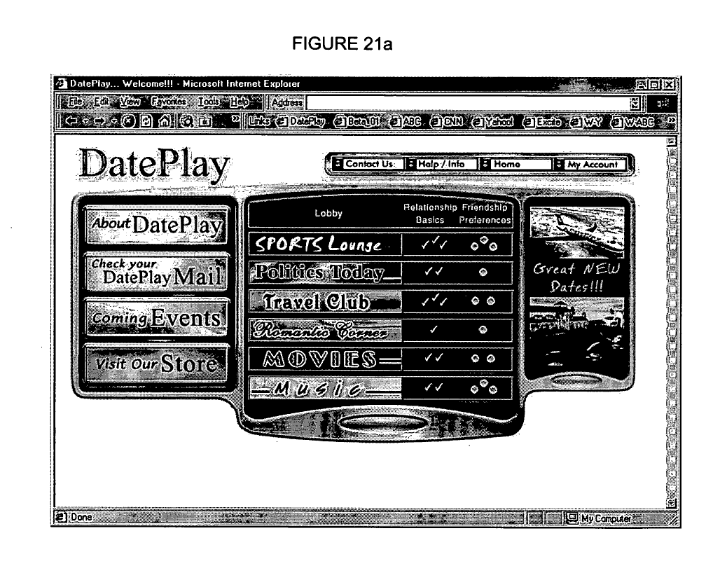

Thus, now turning back to FIG. 9, the web server 11 having determined and stored the concentration of compatible friends and potential mates in each active room, sub-lobby and lobby, the process of subscriber navigation to a desirable chat room may begin. That is, in Step 410, in response to an “Enter Chat Room” selection by an existing subscriber the web server 11 returns a query form page initiating a process for navigating through the available chat room lobbies. In particular, the web server 11 returns a web page allowing entry of a sports lobby choice, a politics lobby choice, a travel, lobby choice, a romantic conversation lobby choice, a move/film lobbies choice and a music lobby choice. For example, FIG. 21 depicts an exemplary web page with image maps with conventional displayed “buttons” corresponding to these choices. FIG. 21a depicts a similar web page in accordance with an alternative embodiment.

As noted above, the lobbies are preferably stored in a relational database specifying the associations amongst lobbies, sub-lobbies and rooms. Also, in a further aspect of the present embodiment, the web page of FIG. 21 also displays indicators showing the concentration of compatible friends and mates in each active lobby. Here, the displayed indicators comprise one to three check marks reflecting the concentration of compatible mates and one to three green lights reflecting the concentration of compatible friends. Again, this information relating to the concentration of compatible participants is derived from the concentration variables stored in Step 400 of FIG. 9 and determined in accordance with the discussion of FIG. 10. By providing for the display of indicators showing the concentration of likely compatible friends and mate, the dating related web site allows more informed user navigation to a desired chat room.

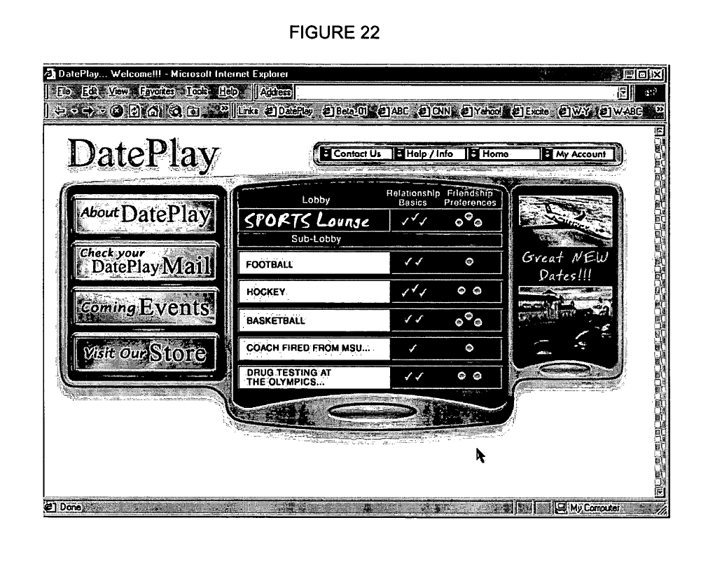

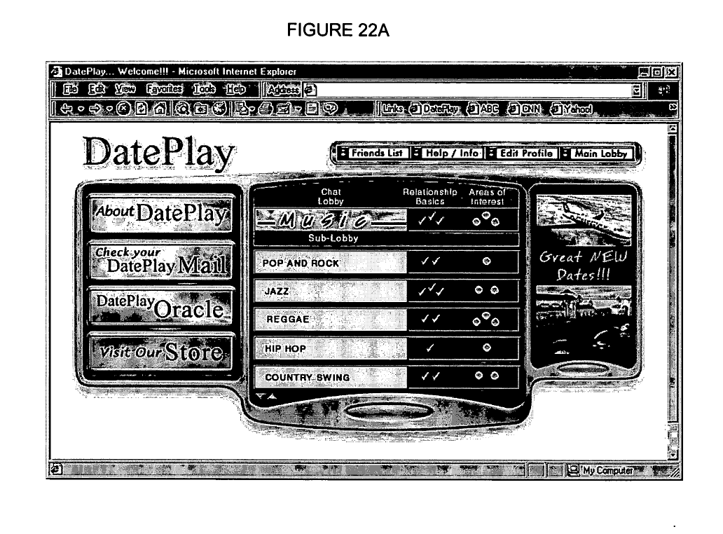

In the presently described embodiment, the user selects the “sports lounge” choice in Step 420 and, in response, in Step 430 the web server 11 returns a web page allowing entry of a sports “football” sub-lobby choice, “hockey” sub-lobby choice, “basketball” sub-lobby choice, “coach recently fired at MSU” sub-lobby choice and “drug testing” sub-lobby choice. For example, FIG. 22 depicts an exemplary web page with image maps with conventional displayed “buttons” corresponding to these choices. The first three choices, “football,” “hockey,” and “basketball,” refer to sub-topics of discussion involving particular sports within the broader category of the “sports” topic chosen in Step 420. The last two choices, “Coach fired at MSU” and “drug testing,” refer to sub-topics of conversation involving currently controversial sport-related issues within the broader category of the “sports” topic chosen. Also, as with FIG. 21, the web page also displays indicators showing the concentration of compatible friends and mates in each active sub-lobby within the chosen “sports” lobby. Again, the displayed indicators comprise one to three check marks reflecting the concentration of compatible mates and one to three green lights reflecting the concentration of compatible friends. And again, by providing for the display of indicators showing the concentration of likely compatible friends and mates, the dating related web site allows more informed user navigation to a desired chat room.

In an alternative embodiment, the user selects the music lobby in Step 420 and a sub-lobby screen such as that shown in FIG. 22a is displayed.

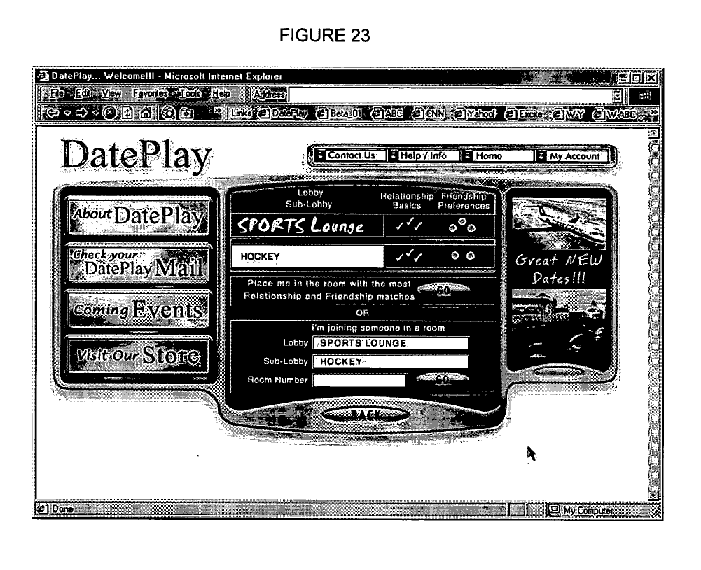

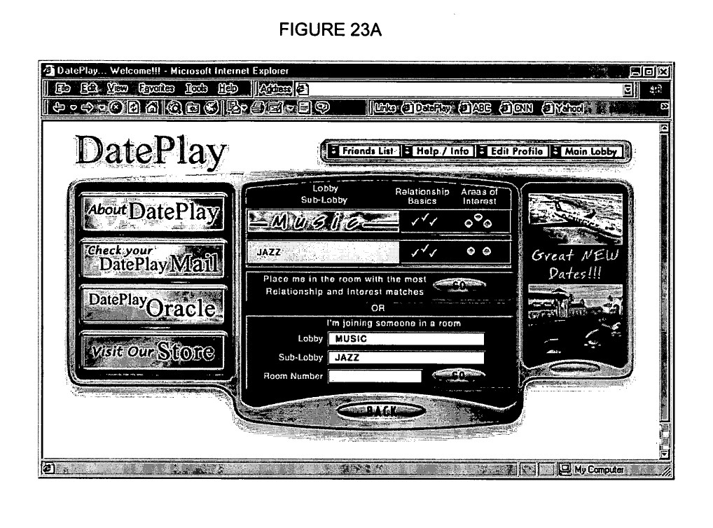

Getting back to the presently described embodiment, the user selects the “hockey” sub-lobby choice in Step 440 and, in response, in Step 450 the web server 11 returns a web page allowing a choice of either automatic navigation to a desired chat room within the chosen sub-lobby, or manual selection of a chat room within the chosen sub-lobby. For example, FIG. 23 depicts an exemplary web page with query form fields and image maps with conventional displayed “buttons” corresponding to these choices. (FIG. 23a shows a similar screen wherein the user instead specified the “music” lobby and “jazz” sub-lobby choices).

If the user specifies a room number in the query field and selects the manual navigation choice, the web server 11 determines a chat room in accordance with the user's choice in step 460. Otherwise if the user selects the automatic navigation choice, then in Step 470 the web server 11 determines a chat room using an algorithm for automatically determining a chat room within the selected sub-lobby having optimally compatible participants.

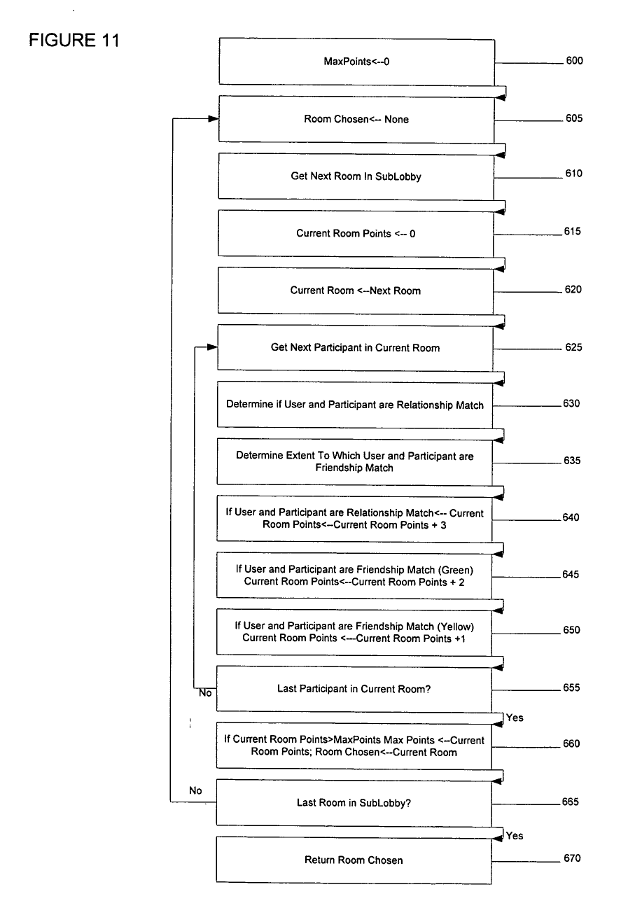

FIG. 11 shows an exemplary method for automatically determining for the user, given a selected sub-lobby, a chat room having optimally compatible participants. In particular, the exemplary process is initiated in Steps 600 and 605, with “MaxPoints” and “Room Chosen” variables initialized to zero and “none,” respectively.

Next in Step 610 the next room (that is, the first room in the first iteration) in the sub-lobby is retrieved by the web server 11. In Step 615 a “Room Points” variable for the retrieved room is set to zero and in Step 620 the current room is identified as the room retrieved.

Next in Step 625 the next participant (that is, the first participant in the first iteration) in the retrieved room is retrieved by the server 11. In Steps 630 and 635, the web server determines whether the user and the retrieved participant are a relationship match, the extent to which the user and the retrieved participant are likely compatible on a friendship level and whether or not the level of friendship compatibility exceeds certain thresholds.

FIG. 12a shows in greater detail the step of determining whether there is a relationship match between the user and retrieved participant as depicted in Step 630 of FIG. 11. In particular, as depicted in Steps 700-730, the web server 11 uses the profiles of the retrieved participant and user to determine if either: a) the retrieved participant is not of the gender desired by the user; b) the retrieved participant is not within the age range desired by the user; c) the participant is outside a city the user desires to meet people in; d) the participant is outside the region the user desires to meet people in; e) the participant is outside the country the user desires to meet people in; f) the participant is a member of a religion the user stated he preferred not to date; or g) the participant is not a member of a religion the user stated he preferred to date. If all of these conditions are false, then in Step 735 a “Relationship Match” variable is set to true and in Step 745 the “Relationship Match” variable is returned indicating a relationship match between the user and participant. Otherwise, if any one of the conditions considered in Steps 700-730 is true, the “Relationship Match” variable is set to “false” in Step 740 and is returned in Step 745 indicating no relationship match exists between the user and participant. As desired, the “relationship match” may include “friendship match” criteria of the type described below in connection with FIG. 12b.

FIG. 12b shows in greater detail the step of determining the extent to which the user and the retrieved participant are compatible on a friendship level and whether or not the level of friendship compatibility exceeds certain thresholds as depicted in Step 635 of FIG. 11. In particular, in Steps 750 and 755, the “Points Earned” and “Points Possible” variables are initialized to zero.

In Steps 760 through 775, the web server 11 cycles through each area of interest specified by either the user or the participant. Such areas of interest (e.g., books, movies) are specified depicted in FIG. 19 and are stored in subscriber profiles as described earlier. In the presently described embodiment, the web server 11 or a database associated with the web server 11 also includes a database of associating weighting values (i.e., a number of points) with each area of interest. For “sports” may have an associated value of 50 points, while “books” may have an associated value of 100 points. The weighting value of the areas of in interest is a judgment that the site provider may make based on a variety of factors and effectively allows the site provider to prioritize the importance of areas interest with respect to the compatibility determination (e.g., having sports activities in common may be considered more important than having an interest in books in common). In Step 760, the web server 11 retrieves the next area of interest specified by either the user or participant. If both the user and the participant specified the area of interest (e.g., books), then in Step 765 the weight value of the area of interest is retrieved and added to the “Points Earned” variable value and to the “Points Possible” variable value. Otherwise, in Step 770, if only one of the user or participant have the area of interest in their profiles, only the “Points Possible” variable is incremented by the weight value of the area of interest. In Step 775, the web server 11 checks if there are other areas of interest specified by either the user or participant and, if so, processing begins again with Step 760 and continues until all areas of interest specified by either the user or the participant have been processed.

Next, in Steps 780 through 787, the web server 11 cycles through each of a set “area of interest combinations” stored at the web server 11 or an associated database. In the presently described embodiment, “area of interest combinations” are combinations comprising two areas of interest (e.g., hockey and skiing, movies and theatre) for which the site provider has provided an association. Preferably such associations are implemented with links in a relational database storing the area of interest combinations. In the presently described embodiment, the areas of interest combinations are created by the site provider to account for the fact that two individuals may have similar areas of interest even if they do not specify an identical area of interest. For example, a participant that specified “skiing” as an area of interest may have interests similar to a participant specifying other winter sports, such as “hockey” as an interest. If the site provider determines that this would in general be the case, then the area of interest combination “skiing-hockey” can be included in the relational database. Further, as with areas of interest, the web server 11 of the presently described embodiment, or a database associated with the web server 11, also includes records associating weighting values (i.e., a number of points) with each area of interest combination. For example, a “skiing-hockey” area of interest combination may have an associated point value of 20 points while a “movie-theatre” are of interest combination may have an associated point value of 10 points. As with the weighting of areas of interest, the weighting values associated with area of interest combinations allow the site provider to prioritize the importance of area interest combinations and their respective impact on the compatibility determination (e.g., if a first participant enjoys hockey while a second enjoys skiing, that fact may be considered more relevant than if the first participant enjoys movies while the second enjoys theatre). In Step 780, the web server 11 retrieves the next area of interest combination in a database. If the user specified one component of the area of interest combination pair while the participant specified the other component, then in Step 785 the weight value of the area of interest combination is retrieved and added to the “Points Earned” variable value and to the “Points Possible” variable value. In Step 790, the web server 11 checks if there are other area of interest combinations in the database storing this information and, if so, processing begins again with Step 780 and continues until all area of interest combinations in the database have been processed.

Next in Step 790, a “Percentage Match” variable is set to the “Points Earned” value divided by the “Points Possible” value. The “Percentage Match” variable indicates the degree to which there is a friendship compatibility between the user and participant. Next, in Step 792, the “Percentage Match” value is discretized by characterizing the level of friendship compatibility into one of three categories. That is, if the “Percentage Match” value is greater than or equal to a certain threshold value (e.g., 80%), then a “Friendship Match” variable is set to “green” indicating a high degree of friendship compatibility between the user and participant. Otherwise, if the “Percentage Match” value is less than the threshold value but greater than or equal to another threshold value (e.g., 60%), then the “Friendship Match” variable is set to “yellow” indicating a medium degree of friendship compatibility between the user and participant. Otherwise, if the “Percentage Match” value is less than both threshold values, the “Friendship Match” variable is set to “red” indicating a low degree of friendship compatibility between the user and participant.

Note that the matching algorithm of the present invention is in no way intended to be limited to FIGS. 12a or 12b. In alternative embodiments, the process of determining whether a user and retrieved participant are compatible friends may be implemented, perhaps more efficiently, using a single loop program structure, rather than a two loop program structure. For example, in the following pseudocode, data is stored for each registered player corresponding to that player's interest. The data is structured such that each such interest is also stored with four similar or often related interests, thus also specifying four area of interest combinations formed partly by the players interest. For example, the following:

Interests=[1(Animals and Pets),[37(Recreation),33(Parenting),23(Horses), 19(Environmental)]]

represents data stored for one registered player representing one of the player's interests (animals and pets) as well as four other interests that may often be correlated with a love of animal and pets. Once such a data structure with corresponding data is created for each interest for each player, the following may be used to determine whether a user and retrieved participant are compatible friends:

```
  Points_for_Green = 200
  Points_for_Yellow = 100
  Points_for_Match = 100
  Points_for_A1 = 70
  Points_for_A2 = 40
  Points_for_A3 = 20
  Points_for_A4 = 10
For each person
  Load all of the person's interests
For each person (P1)
  For each other person (P2)
    Initialize Score for P1_P2 to 0
    For each interest that P1 has (I)
      If P2 has interest I, add Points_for_Match to Score for P1_P2
      Else If P2 has A1, add Points_for_A1 to Score for P1_P2
      Else If P2 has A2, add Points_for_A2 to Score for P1_P2
      Else If P2 has A3, add Points_for_A3 to Score for P1_P2
      Else If P2 has A4, add Points_for_A4 to Score for P1_P2
    If Score for P1_P2 >= Points_for_Green then
      The light for P2 on P1's screen will be green
    Else If Score for P1_P2 >= Points_for_Yellow then
      The light for P2 on P1's screen will be yellow
    else
      The light for P2 on P1's screen will not show up
```

Interests Matching with Weighting Function

In the above embodiments, members in group chat rooms are placed in such chat rooms based on a calculation of interest-based compatibility to each other member of the chat room. The degree of compatibility among specific members of the chat room is conveyed by display of a light that is alternatively green, yellow, or unlit relative to each other member of the chat room. The computation of compatibility is based on a true-false response set by each member relative to a set of pre-defined interests. Each interest is examined for each member combination and aggregated to a total number of common selected interests.

In a presently preferred embodiment, the interest-based compatibility is instead assessed as a function of an indication by members concerning not just a true-false response set but the degree of subscription or non-subscription a member has to each interest. That is, members are provided the opportunity to indicate on a scale of −5 to +5 the degree to which they are interested or disinterested in a given item or interest area (example: Art). The results are then accumulated to establish the degree of interest-based alignment among members. A sample interface for eliciting such information is illustrated in FIG. 19d.

In accordance with this embodiment of the invention, the dating website operator may choose whether the degree of interest is best assessed based on two competing approaches:

(1) The total number of matching interests.

(2) The degree of alignment among matching interests.

The algorithm to accommodate the total number of matching interests (the first approach) may be summarized as follows:

(1) Compare each interest item for two members.

(2) Ignore the interest item unless both members are interested in the item (+1 through +5) or both members are disinterested in the item (−1 through −5).

(3) In the case of mutual interest or mutual disinterest in the item, note each such occurrence as a common perspective on the interest.

(4) Accumulate the total number of common perspectives.

(5) Assess the degree of compatibility as a function of the total number of common perspectives.

On the other hand, the algorithm to accommodate the degree of alignment among matching interests (the second approach) may be summarized as follows:

(1) Compare each interest item for two members.

(2) Ignore the interest item unless both members are interested in the item (+1 through +5) or both members are disinterested in the item (−1 through −5).

(3) In the case of mutual interest or mutual disinterest in the item, note each such occurrence as a common perspective on the interest.

(4) In the case of mutual interest or mutual disinterest in the item, obtain the absolute difference between each member's ranking of that item. (Example: −5 versus −3=2)

(5) Accumulate the total number of common perspectives.

(6) Accumulate the total value of absolute differences.

(7) Assess the degree of compatibility as a function of the total value of the absolute difference between each member's ranking of all items divided by the total number of common perspectives.

(8) The highest degree of correlation between two members will appear in the form of the lowest absolute difference divided by the total number of matching interest items. For example, a ratio of 1 divided by 7 is a stronger match than a ratio of 1 divided by 3.

(9) In the case of members for whom the degree of match among common perspectives is perfect, i.e., 0, then a sort will be performed under which the higher degree of correlation will be attached to matches for which the denominator (total common perspectives) is higher. For example, two members with 0 deviation among 7 interests will be ranked higher than two members with 0 deviation among 5 interests. In both cases, the light will be set to green; however, the order in which each member is displayed to the common matching member will connote that one has ranked higher than the other.

Such algorithms for determining the total number of matching interests and the degree of alignment among those matching interests may be implemented as follows:

```
User Interaction: User defines member interest filter option
Set member_interest_filter option to “Cumulative”
Display member_interest_filter options
  Cumulative - Sort member matches by interest_match totals
  Ratio  - Sort member matches by dividing interest_match totals
      by number of member interest matches
If user selects “Ratio”
  Set member_interest_filter to “Ratio”
Store Result
User Interaction: User defines interests
Display System Defined Interests
User selects importance ranking for each interest that applies to user
Store Result
Interest Match
While not at the end of list
  Where member has matching interests to user
  For each matching interest
    Select user_importance_ranking for matching interest
    Select member_importance_ranking for matching interest
    If member_importance_ranking threshold is the same measure as
      user_importance_ranking
        Add absolute difference between user_importance_ranking
          and member_importance ranking to member_interest_{—}
          match subtotal
        Add 1 to member_match_total
    End If
  Repeat
  Sum member_interest_match subtotals as member_interest_match_{—}
  total
If member_interest_filter is “Cumulative”
  Sort members for user interest match by ascending member_interest_{—}
  match_total
If member_interest_filter is “Ratio”
  Sort members for user interest match by ascending result of dividing
  member_interest_match_total by member_match_total
```

### EXAMPLE

Assume that a user and two members of the dating web site of the invention have the following interest weightings in the listed categories:

| | | | Food & | | |
|---|---|---|---|---|---|
| | Auto | Collectibles | Wine | Fashion | Internet |
| User | 1 | −1 | −3 | 4 | 3 |
| Member 1 | 0 | 0 | −2 | 4 | 1 |
| Member 2 | 3 | −2 | −3 | 0 | 3 |

The user would have the following matches with Member 1:

Food & Wine

User=−3

Member=−2

Add 1 to Member 1 member_interest_match subtotal

Add 1 to Member 1 member_match_total

Fashion

User=4

Member=4

Add 0 to Member 1 member_interest_match subtotal

Add 1 to Member 1 member_match_total

Internet

User=3

Member=1

Add 2 to Member 1 member_interest_match subtotal

Add 1 to Member 1 member_match_total

member_interest_match=3

member_match_total=3

and the following matches with Member 2:

Auto

User=1

Member=3

Add 2 to Member 2 member_interest_match subtotal

Add 1 to Member 2 member_match_total

Collectibles

User=−1

Member=−2

Add 1 to Member 2 member_interest_match subtotal

Add 1 to Member 2 member_match_total

Food & Wine

User=−3

Member=−3

Add 0 to Member 2 member_interest_match subtotal

Add 1 to Member 2 member_match_total

Internet

User=3

Member=3

Add 0 to Member 2 member_interest_match subtotal

Add 1 to Member 2 member_match_total

member_interest_match=3

member_match_total=4

In this embodiment, if the user or a member is neutral, then the member_interest_match is not determined as the member has no preference for that item. Of course, a differential with the neutral could also be calculated in accordance with the invention.

If the user's member_interest_filter is set to “Cumulative,” then a member sort yields:

Member 1 (3)

Member 2 (3)

On the other hand, if the user's member_interest_filter is set to “Ratio,” then a member sort yields:

Member 2 (¾=0.75)

Member 1 (3/3=1)

An additional information intake screen may be used to permit member matches to be included in the same algorithm for the purposes of further honing the interests match. The screen illustrated in FIG. 19e, titled My Pursuits, requests the member to indicate the amount of importance he/she places on a range of activities. The possible answers to each activity and their associated values are:

| | |
|---|---|
| −2 | Not at All Important |
| −1 | Not Very Important |
| 0 | Important |
| 1 | Very Important |
| 2 | My Primary Focus |

Each match between members will be aggregated to the total of common perspectives as described above. Likewise, the degree of match between members will be included in the total value of absolute differences and compared to the total of common perspectives as discussed above with respect to the degree of alignment method. Over time, as the web site operator comes to assess the validity of the Interests set versus the Pursuits set, the associated values of the Pursuits set may be adjusted to a wider or tighter range than shown above.

Automatic Navigation

Turning back now to the automatic navigation algorithm of FIG. 11, having determined a value for the “Relationship Match” and “Friendship Match” variables in Steps 630 and 635 (and as detailed in FIGS. 12a and 12b and preferably modified to include weighting criteria as described above), in Step 640 the web server 11 next increments the “Room Points” value for the retrieved room by three if “Relationship Match” has a value of “true.” In Step 645, the web server 11 increments the “Room Points” value for the retrieved room by two if “Friendship Match” has a value of “green.” Similarly, in Step 650, the web server 11 increments the “Room Points” value for the retrieved room by one if “Friendship Match” has a value of “yellow.” If none of these conditions apply, then the “Room Points” value for the retrieved room is not incremented as a result of processing of the participant retrieved in Step 625.

In Step 655 the server 11 checks whether the participant retrieved in Step 625 is the last participant in the retrieved room. If there are additional participants, Steps 625-655 are repeated so that all participants in the retrieved room are processed.

Once all participant in the retrieved room have been processed, in Step 660, the server 11 determines whether the value of “Room Points” for the retrieved room exceeds the value currently stored in the “MaxPoints” variable. (Note that this condition will always be satisfied for the first room retrieved in the process depicted in FIG. 11). If so, then the “MaxPoints” variable is set to the “Room Points” value for the retrieved room and the “Room Chosen” variable is set to the retrieved room. Next in Step 665 the server 11 determines whether the retrieved room is the last to be processed in the selected sub-lobby. If there are additional rooms in the selected sub-lobby, then steps 610 through 660 are repeated until all rooms in the selected sub-lobby have been retrieved and processed. In this way, “MaxPoints” is always set to the “RoomPoints” value for the room having the greatest “Room Points” while “Room Chosen” is assigned a value identifying that room.

Finally, in Step 670 the “Room Chosen” variable is returned as an indicator of the chat room having the most optimally compatible participants.

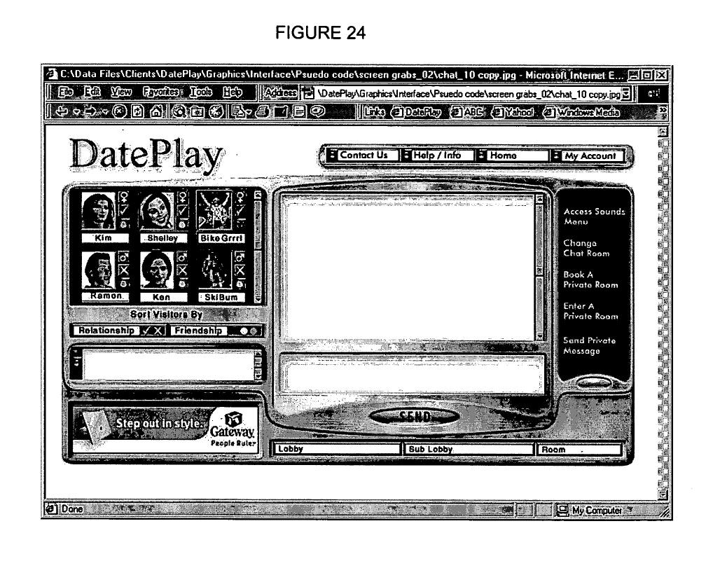

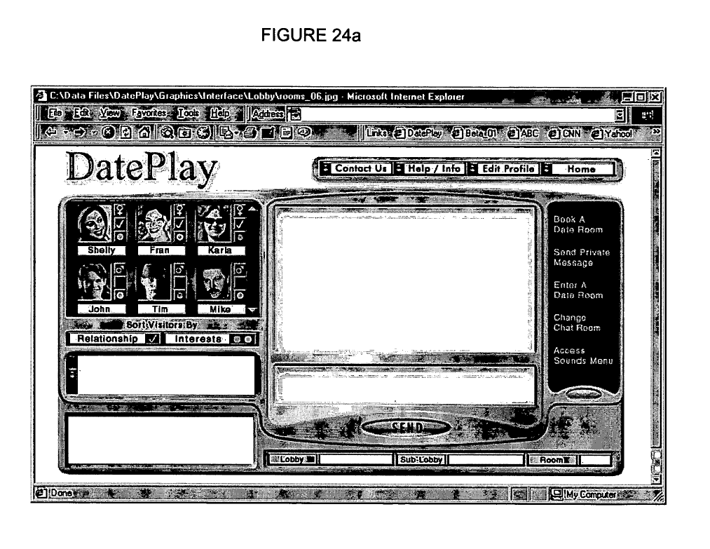

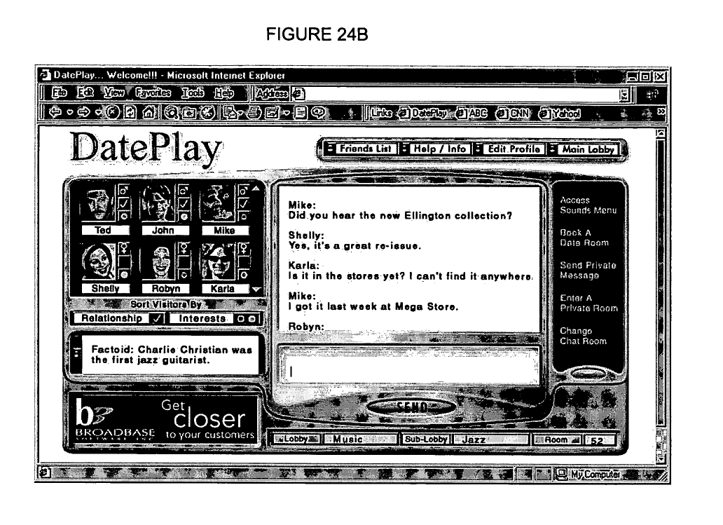

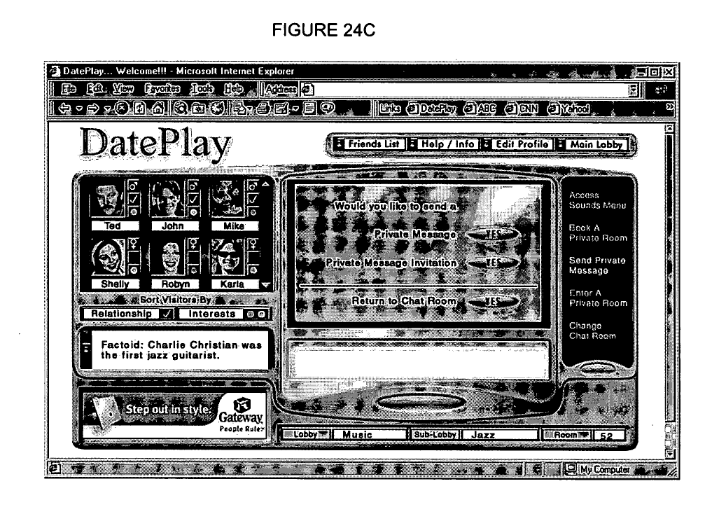

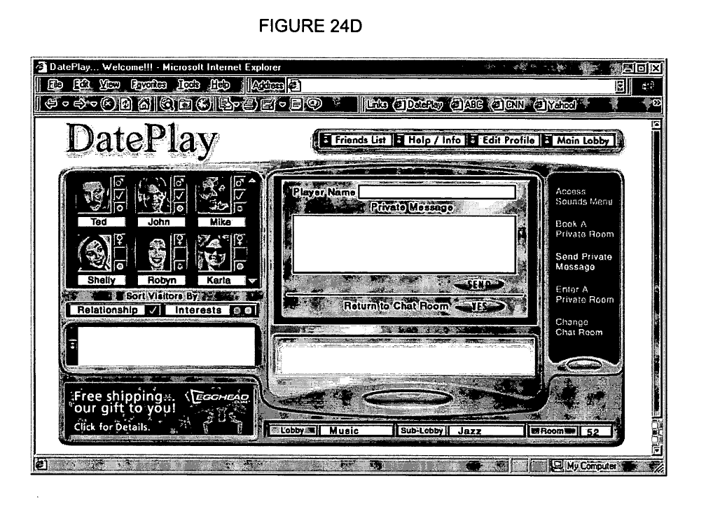

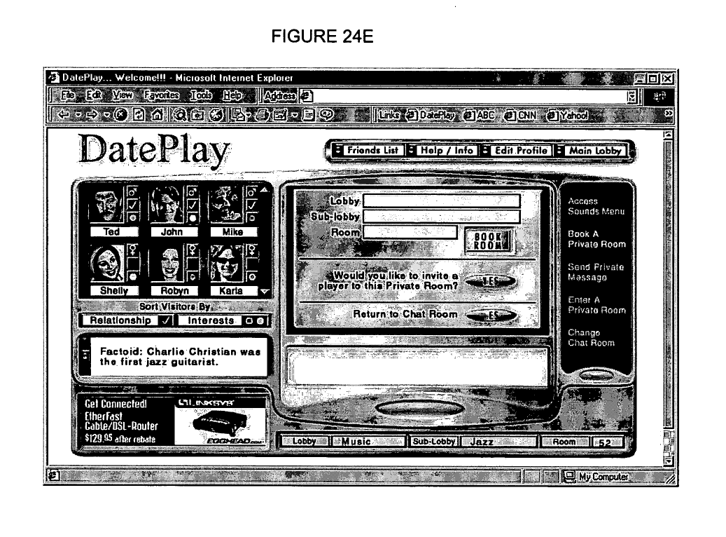

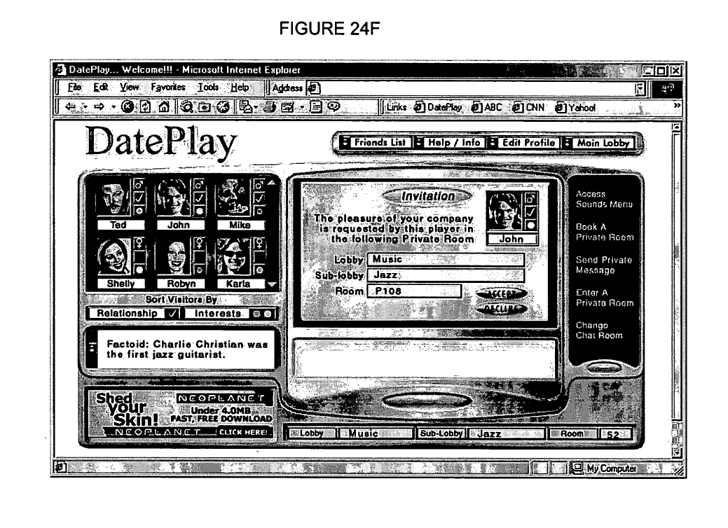

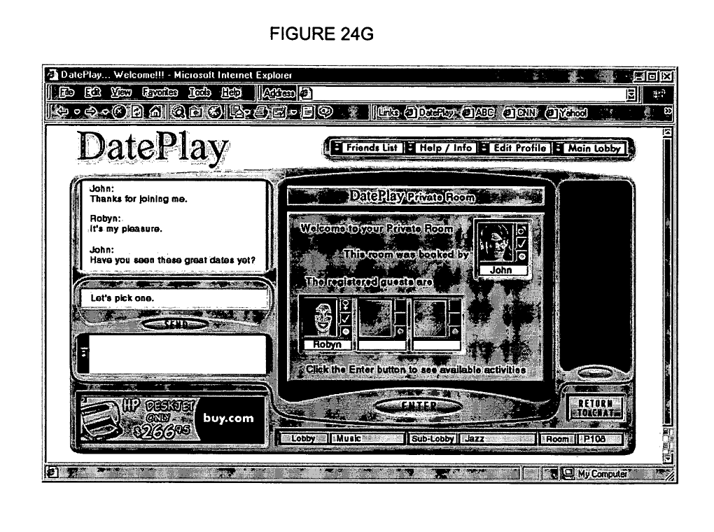

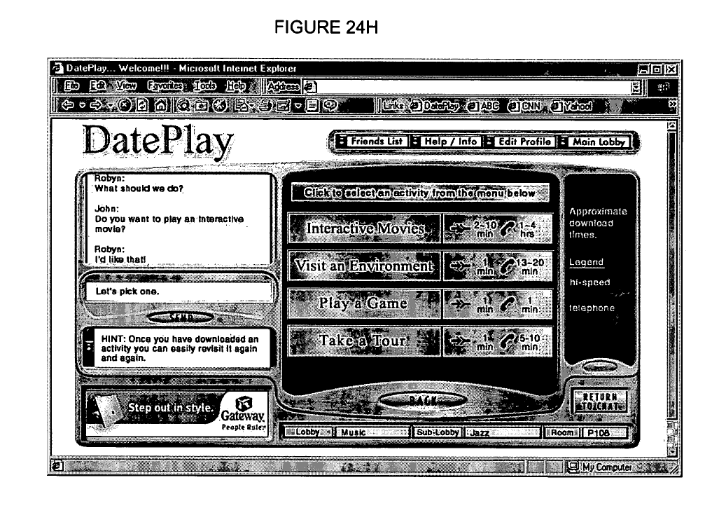

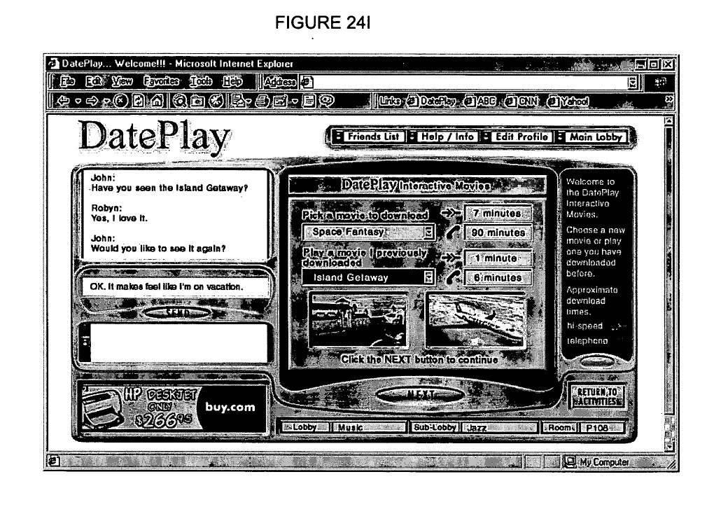

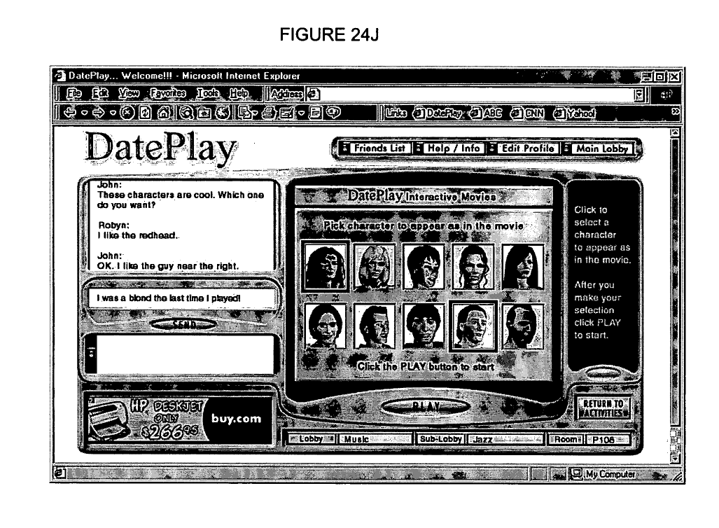

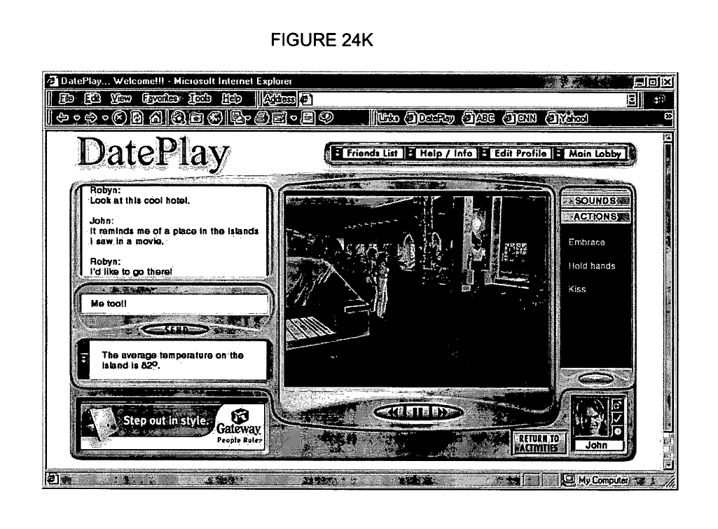

Turning back to the user navigation process of FIG. 9, in Step 480, once the chat room is determined, whether automatically in accordance with the “Room Chosen” variable discussed in connection with FIG. 11 or manually by the user, the web server 11 (or a chat server) finally serves a page representation of a chat room environment corresponding to the chat room determined in Step 460 or 450. (The page representing a chat room environment may also be generated locally by chat software on the client 99. In addition note that the chat server and web server may represent respective software components on a single physical server). An exemplary page representing a chat environment and facilitating an Internet Relay in accordance with the presently described embodiment is shown in FIGS. 24 an 24a.

Internet Relay Chat is known in the art as a conventional way for Internet subscribers to “chat” with one another via keyboards 195 in real time. To facilitate this process, the client 20 may have any chat client software installed thereon that connects to a chat server. In the presently described embodiment, the user's client 20 has chat client software installed that may be downloaded from the dating related web site in conventional fashion. The client 20 is also connected and logged on to a chat server and channel upon receipt of the chat room page of FIGS. 24 and 24a. In FIGS. 24 and 24c, the messages are viewed from the large center window depicted.

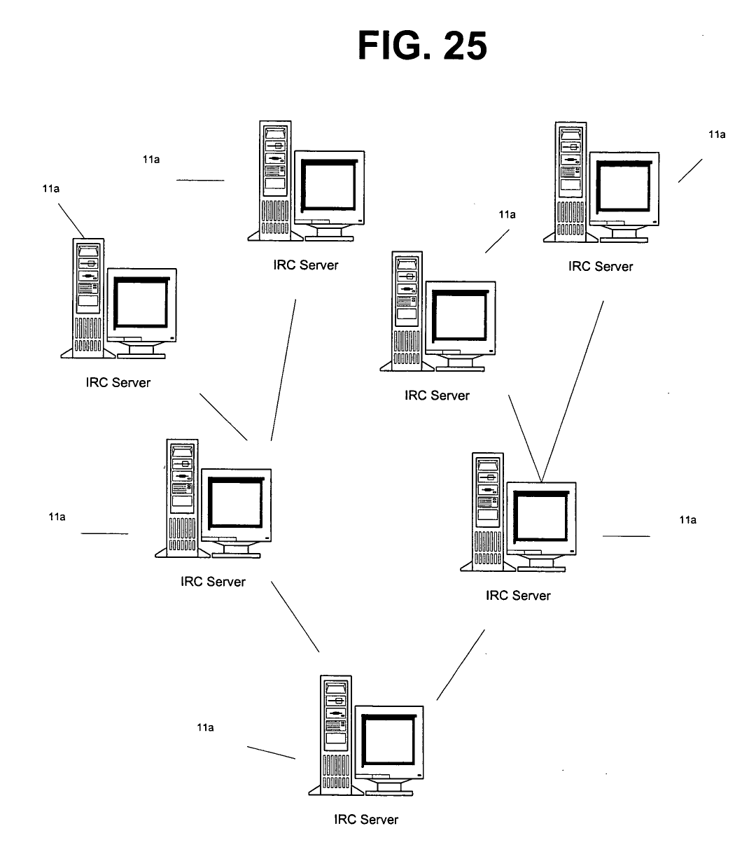

In conventional fashion, the chat server is connected in the Internet with other chat servers in conventional “spanning tree” fashion (shown in FIG. 25) to speed the transmission of participant messages from server to server. User messages are sent from the keyboard 195 by the client chat software to the connected chat server and are then broadcast from chat server to other chat servers to which participants have access. Messages are thus broadcast to the client software of other participants logged in to the chat room selected in real time, and such participants have the same ability to generate and broadcast messages.

In the presently described embodiment, as in a typical chat room environment, each message is associated with a handle identifying the sender of the message. In the chat environment depicted in FIG. 24, the screen names (e.g., “kim,” “shelly,” “ken”) stored in participant user files function as such handles. Further, in an advantageous aspect of the present invention, in addition to screen names, the screen image icons stored in participant profiles are also associated with the chat participants in the chat environment depicted in FIG. 24. (Again, these icons may represent pre-defined icons that allow the participants to maintain anonymity, or actual photos of the participants as shown in the alternative chat room environment depicted in FIG. 24). Further as depicted in FIG. 24, in the exemplary chat environment illustrated, if there is a relationship match between the user and a participant, then a checkmark will be shown in the relationship possibility indicator displayed with the screen icon, screen name and gender of the participant. In the presently described embodiment, the web server 11 determines whether there is a relationship match among chat participants in accordance with the exemplary algorithm discussed in connection with FIG. 12a. In alternative embodiments, a separate chat server performs those functions required to facilitate chat functionality. Similarly, if there is a friendship match between the user and a participant, then a green light will be shown in the friendship possibility indicator displayed with the screen icon, screen name and gender of the participant. Again, in the presently described embodiment, the web server 11 may determine the extent of friendship compatibility among chat participants and whether that compatibility exceeds a threshold indicating a friendship match (i.e., “green”) in accordance with the exemplary algorithm discussed in connection with FIG. 12b and the weighting algorithms described above.

In a further advantageous aspect of a chat environment featured in the presently described embodiment, the web server 11 (or chat server) will continually monitor the profiles of all players on the system and advise the participants when rooms develop that have more Friendship or Relationship matches than the chat in which they are currently participating. This determination may be derived by repeatedly executing an algorithm such as the exemplary algorithm discussed in connection with FIG. 10.

Also, in yet another advantageous aspect of a dating related web site in accordance with an embodiment of the present invention, if the user engages in chat (FIG. 24b shows a series of chat messages among participants) and finds a chat participant desirable, the user and that participant may choose to take advantage of a “virtual date” feature.

In particular, apart from the “Send” button for sending normal chat messages, the screen in FIG. 24b also features a “Send Private Message” button. When the user selects the button while participating in a chat session, the web server 11 (or chat server) responds by forwarding data corresponding to a screen such as that shown in FIG. 24c. Next, in the presently described embodiment, the user elects to send a private message and a “Send a Private Message Screen” is caused to be served from the web sever 11 (or chat server). An exemplary screen interface is depicted in FIG. 24d. This screen allows the user to specify a private message which is sent to only the recipient indicated in the “Player Name” field. Upon selection of the “Send” button, the client computer generates packets comprising the specified message destined for the web server 11 (or chat server(s)). The web server (chat server 11) maintains a network address listing for the computer of each participant in the chat room and maintains associations between participant identifiers and corresponding network addresses in accordance with techniques known in the art. Thus, the web server (chat server) 11 can complete the private message by causing the message to be sent only to the computer corresponding to the recipient specified by the sender. In this way, participants can conduct private virtual conversations that may express interests and feelings they do not wish to make public.

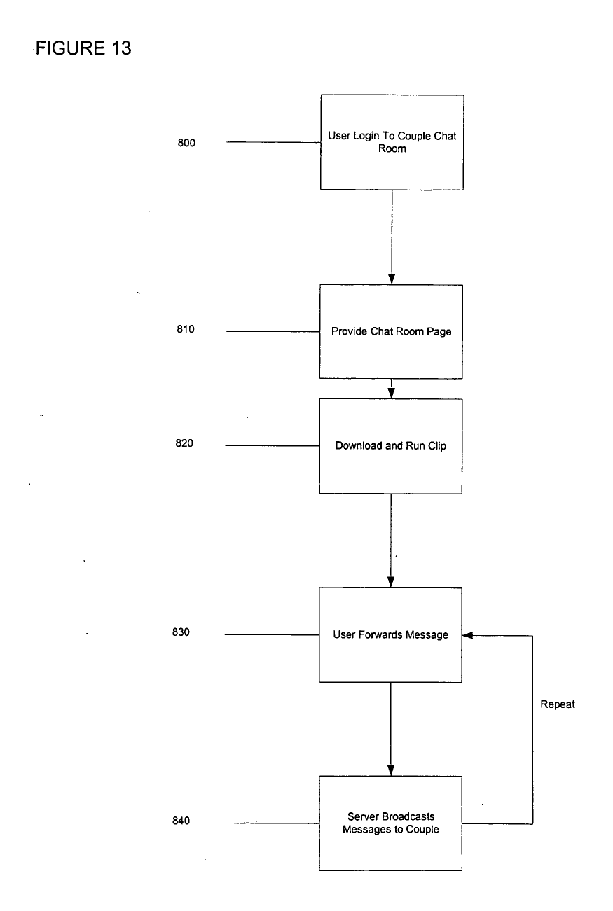

Once participants engage in such a private conversation, they may decide to use the sites virtual dating facility. Thus, turning now to FIG. 13, in Step 800, one of the two conversants decides to book a private room. To do so, the player selects the “Book a Private Room” button shown in FIG. 24d. In response the web server 11 (chat server) serves data corresponding to a screen such as that shown in FIG. 24e. The screen gives the player the option of booking a room and inviting another player to the private room.

In response, the web server 11 (chat server) causes a screen such as that depicted in FIG. 24f to be served to the invited player's computer. Again, this is accomplished as the web server 11 maintains lists of network addresses and corresponding participants for each participant in the chat room.

In the present described embodiment, the invite player selects the “Accept” button. In response, in Step 810, data corresponding to a screen such as that shown in FIG. 24g is served to both players' computers. The page allows the players to engage in a private chat.

When either player clicks “Enter” to proceed, an interface such as that shown in FIG. 24h is displayed on both player screens. The screen provides choices corresponding to virtual activities the players may engage in. Again, all the while the while (chat) server 11 allows the players to participate in a private chat. In this way, the players can discuss a choice before making it.

In the presently described embodiment, one of the players selects the “Interactive Movies” selection. As result, a screen such as that shown in FIG. 24i is displayed on both player screens. The interface allows the players to select the interactive movie clip, or “Virtual Date,” that the players wish to see. For example, the players may select an “Island Getaway” vacation or a “Space Fantasy” vacation. In the presently described embodiment, an interface such as that depicted in FIG. 24j is also displayed on the player screens allowing each player to specify an icon that will represent them during he course of their “virtual date.”

In response to the players' selections, in Step 830, a digital video clip corresponding to the choice is downloaded and executed on both player client computers using techniques known in the art. In the presently described embodiment, the clip also displays two icons—one male and one female—that are displayed as taking part in the video clip. In one embodiment of the present invention, the players respective icons respond in interactive fashion-that is, the icons are controlled by each player. For example, in some scenes a layer could elect to initiate a ‘hug’ action which would cause the screens to both players to show a ‘hug’ sequence. In this embodiment, the interactive movies also include sound effects that can be initiated by one player and heard by both. In addition, the both players are given the continued ability to engage in private chat as depicted in the upper left corner of FIG. 24k and Steps 830 and 840 of FIG. 13.

Physical Attractiveness Evaluation and Filtering

The present invention further includes two methods for evaluating the physical attractiveness of individual members of an online dating service and factoring physical attractiveness criteria into member searches. As will be explained in detail below, a first approach accumulates a total number of “attractive” votes per every hundred voters to infer the degree to which someone is considered attractive, puts them in groups and then searches the member database based on the groups the user wants to see relative to his/her own ranking. A second approach instead sets up a table of rankings (1 through 10) that is cross-correlated to the dominant rank of the members doing the ranking and then searches the member database looking for members who have been assigned a given rank by other members who have the same dominant rank as the user.

### First Embodiment of the Physical Attractiveness Evaluation

The physical appearance of each members in the system is evaluated and used as part of the matching algorithm. The system may display target members for evaluation by, for example, allowing a user to choose an option of evaluating new members, of evaluating members encountered in a chat room or other remoting service provided by the system, of evaluating members that contact that member, or of evaluating members found in a search. When a member evaluates a target member, the evaluating member's ID, target member's ID and rating are stored and the target member's rating average is updated.

In this fashion, each member of the member pool is evaluated as to his/her physical attractiveness by other members of the member pool. The evaluation is based on pictures provided by the member and is separated into two primary categories: Physically attractive or Not physically attractive. In accordance with a first embodiment, members rank other members' pictures according to whether the member being ranked is judged to be:

Very physically attractive

Above average physically attractive

Average physically attractive

Not physically attractive

Members receive no (0) points if the ranking member assigns the characteristic of “Not physically attractive” and receive one (1) point if the ranking member assigns any other of the three remaining characteristics “Very physically attractive”, “Above average physically attractive”, or “Average physically attractive”. A tally of points is maintained and members are placed into one of four groups based on the total number of points they have accumulated. Of course, members may also be granted more points for being more physically attractive.

In accordance with the first embodiment of the physical attractiveness rating feature of the invention, it is assumed, by way of example, that the online dating site has 100 members and that each member has ranked every other member by the above four characteristics. It is next assumed that 10 members received the characteristic “Very physically attractive”, 25 members received the characteristic “Above average physically attractive,” 45 members received the characteristic “Average physically attractive,” and 20 members received the characteristic “Not physically attractive.” The above results could be illustrated as follows:

10 members were voted “Very attractive” by 100 members

25 members were voted “Above average attractive” by 100 members

45 members were voted “Average attractive” by 100 members

20 members were voted “Not attractive” by 100 members

Since each member has been ranked by every other member, the system knows with certainty how each member views all other members with respect to physical attractiveness and can limit the searches of any member accordingly. However, in the case of some online dating sites, the system cannot know how each member views every other member since there are too many members to whom each member would have to provide rankings. Consequently, the system will have to infer the classification that a given member would choose to assign to another given member. To accomplish this inference, the system refers to the population of members who have received rankings from other members and correlates those rankings to the rank received by the member who is conducting the search. Note that, to be eligible to conduct an appearance based search, a member preferably will have to have received a predetermined number of rankings, e.g., at least 50 rankings.

Now, assume that the online dating site has 1,000,000 members and that the following points have been accumulated:

TABLE 1

| Category | Category Points |
|---|---|
| Physically attractive | 380,000 |
| Not physically attractive | 20,000 |
| Total Rankings | 400,000 |

The system then breaks the “Physically attractive” category into four (4) separate groups. This is done to determine members' relative physical attractiveness within the pool of 380,000 physically attractive members. The remaining 20,000 members are not going to be included in the results of any members searching with the criteria of physical attractiveness since no members ranked them as physically attractive. The groups are delineated by the average number of points received by the members. The group delineations can be modified up or down to reflect whether members believe the site is accurately classifying the physical attractiveness of the pool of members.

The determination of the group to which a member is assigned depends on the total points accumulated by that member relative to the number of members who ranked the member. For example, if a member was judged to be physically attractive by all 100 members who provided rankings, that member would receive a score of 100. If a member was judged to be physically attractive by 70 members who provided rankings, that member would receive a score of 70. If a member was judged to be physically attractive by 50 members who provided rankings, that member would receive a score of 50. If a member was judged to be physically attractive by 15 members who provided rankings, that member would receive a score of 15.

The 380,000 are thus grouped as follows:

TABLE 2

| | Category | Members |
|---|---|---|
| Category | Percentile Cutoff | in Category |
| 1^{st} Group | 90 | 38,000 |
| 2^{nd} Group | 70 | 76,000 |
| 3^{rd} Group | 55 | 95,000 |
| 4^{th} Group | 1 | 171,000 |
| Total Rankings | | 380,000 |

Now assume that the searching member has received at least 50 rankings from other members and that the average of those rankings has resulted in their accumulating 68 points which then places them in the 3^{rd} group. Further assume that the profile of the searching member indicates his/her desire to meet other members who are in the category directly below him/her. No member is informed as to the category to which he/she has been assigned or the category to which other members have been assigned. However, the online dating site knows that the group directly below this member is the 4^{th} group. Accordingly, the results of the search will include only those members who are classified in the 4^{th} group. [Of course, the searching member will have specified other filtering criteria such as a desired age range, location, etc. so the pool of featured profiles returned to the searching member is correspondingly smaller.]

Judgments Within a Group

As noted above, members rank other members' pictures according to whether the member being ranked is judged to be:

Very physically attractive

Above average physically attractive

Average physically attractive

Not physically attractive

However, despite having stored members' judgments as to whether another member was determined to be “Very physically attractive,” “Above average physically attractive,” or “Average physically attractive,” the use of that information was limited above to simply whether a member was judged to be “Physically attractive” or “Not physically attractive”. No weight was given to the more descriptive rankings in order to avoid bias.

If it is now hypothesized that less attractive members of a community may tend to give higher rankings to more attractive people than would be given by other more attractive members of the community and, similarly, that more attractive members of the community may tend to give lower rankings to less attractive people than would be given by other less attractive members of the community, the effect would be to place members in groups to which the other members of the group may tend to disagree as to their inclusion, thereby causing the members of the group to have less confidence in the ability of the website to properly filter members' profiles by the criteria of physical attractiveness.

Accordingly, three further uses of the ranking information are desired: (1) to determine the relative ease or harshness by which specific members of a group judge other members of the group, (2) to apply the determination of the manner in which members rank other members as an important additional indicator of whether two members are a personality match to one another, and (3) to provide an order to assign to the search results as to those members who have been previously judged by the searching member. These uses are described below.

Determining the Relative Ease or Harshness by Which Specific Members of a Group Judge Other Members of the Group

To make a determination of the relative ease or harshness by which a particular member judges other members, a tally is kept for each member within a group as to how he/she judged the other members that were placed in that group by the entire community. For example, within the 2^{nd} group, the following group and individual rankings may be found:

TABLE 3

| | Group | A Member | |
|---|---|---|---|
| | Ranked | Ranked | Member Rankings |
| | Group | Group | Compared to Group |
| Category | Members | Members | Rankings |
| Very physically attractive | 25% | 10% | (60.00%) |
| Above average physically | 30% | 25% | (16.67%) |
| attractive | | | |
| Average physically | 30% | 35% | 16.67% |
| attractive | | | |
| Not physically attractive | 15% | 30% | 100.00% |
| Totals | 100% | 100% | (18.87%) |

The determination can be applied in two ways. For one, the member may be informed of his/her degree of harshness in ranking other members of his/her group and may be asked to indicate whether he/she only wants to see the top 10%, 35%, 70% or 100% of the group. For another, the Category Percentile Cutoffs from Table 2 applied by the community to all its ranked members may be upwardly adjusted so that the 1^{st} group includes only the most physically attractive members of the “Very physically attractive” group, the 2^{nd} group includes more “Very physically attractive” members and less “Average physically attractive” members, and so on.

Determining the Manner in Which Members rank Other Members as an Additional Indicator of Whether Two Members Are a Personality Match to One Another

As noted in detail above, the system of the invention may determine the compatibility of website members from the indications by members of their areas of interest and place compatible members in the same chat room. If it is further hypothesized that the extent to which members may be easy or harsh judges of other members is an important additional indicator of the likelihood of a personality match. In other words, harsh judges of other members may be well regarded by other harsh judges and may be generally disliked by easy judges. The determination of whether a member is a harsh or easy judge of other members is made independently of how the member might view themselves in this regard so the validity of the determination is more assured. Since this personality feature can be expected to impact one's relationships, it is employed as a criterion upon which to associate members in the chat rooms and that members can search just as they might search on criteria such as age ranges, location, and gender.

Providing an Order to Assign to the Search Results as to Those Members Who Have Been Previously Judged by the Searching Member.

The order in which profiles are displayed to the searching member who has elected to use physical attractiveness as a criterion can be set to the extent the searching member may have previously ranked members who are now included in the returned profile list. For example, members who the searching member ranked as “Very physically attractive” will be displayed first then followed by members who the members of the searching members group ranked as “Very physically attractive” and so on through the following categories. Members who the searching member ranked as “Not physically attractive” will be eliminated in the search results even though the community placed them in the searching member's group.

The application of the criteria of physical attractiveness to limit the search results provided to a searching member has been illustrated above. Also of importance is the acceptability of the searching member to each member included in the list of profiles compiled by the search. Some searching members may not be concerned with whether the members of the returned list will be likewise attracted to them. Other members will prefer to further narrow the list only to those members for whom there is two-way attraction. Further, some members may elect to block other members from being able to see them on the system if the other members do not fall into the group to which the searching member has been classified. Note that each member who elects to block or “hide” from other members will be given the choice to specify a range of other groups that are acceptable to him/her. For example, a person in the 1^{st} group might elect to be visible to members of the 2^{nd} and 3^{rd} group but not to be visible to members of the 1^{st} and 4^{th} group. The online dating site operator does not provide or assume those judgments.

All the tests and methodology described above as they are applied to the searching member can be equally applied to the members who are included in the list of members meeting the searching member's qualifications. For those members who elect to narrow the list to only display two-way matches, the web-site will eliminate members from the list when the searching member is not in a category of physical attractiveness the listed member wishes to meet. Likewise, for members who may be clicking through the profiles database, the “clicking” (searching) member will be unable to email or “Quick Message” profiles of members who have excluded them due to physical incompatibility. In the chat rooms, excluded members will not see the picture, profile information, or the chat messages of members that excluded them on the physical attractiveness criteria.

Thus, the present invention provides a mechanism where members rated as “not attractive” by the searcher are automatically deleted from any search results and members not rated by the searcher but collectively rated as being outside of the searcher's range for “physical attractiveness” also may be deleted from the search results. This feature minimizes the possibility of a more attractive person being approached by a person to whom he/she is not attracted in an environment which would otherwise have placed them “face to face”. This solution also minimizes the occurrences of members quitting because they are emailed too frequently by members to whom they are not attracted. Such a problem is magnified when the contact is immediate as in the case of the chat environment.

Pseudocode

The first “physical attractiveness” method of the invention may be implemented in the matching (search) software loaded on the online dating service's website. Sample pseudocode for implementing the techniques of the first method are set forth below:

1) User Interaction: Evaluation of Target Member

Display (target) member for evaluation (by evaluator)

Let evaluator assign a ranking of physical attractiveness to target member

Let evaluator select whether to notify target member that a ranking has been assigned

Do not disclose ranking to target member

Record assigned ranking in database

2) Derive Average Rank of Target Member

For each ranking received by a target member (while not at end of list):

For each ranking of target member where ranking equals Not_attractive

Increment value of target member denominator

For each ranking of target member where ranking equals Attractive

Increment value of target member denominator

Increment value of target member numerator

Repeat (while not at end of list)

Divide numerator by denominator

Store result as Average Rank of Target Member

3) Assign Target Member to a Group

Declare a number of member groups

Delineate groups by percentage of attractive votes received compared to total votes received

Use Average Rank of Target Member to assign target member to group

Example of above procedure (number of groups may change):

Declare four (4) groups delineated as follows:

Group 1—Attractive votes divided by total votes=0% to 25%

Group 2—Attractive votes divided by total votes=26% to 50%

Group 3—Attractive votes divided by total votes=51% to 75%

Group 4—Attractive votes divided by total votes=76% to 100%

4) Modify Groups by Degree of Ease/Harshness of Evaluating Member

For each target member evaluated by Evaluator (while not at end of list)

Accumulate rank of Target Member from evaluator

Accumulate Average Rank of Target Member (from all evaluating members)

Repeat (while not at end of list)

Divide total rank of Target Member from evaluator by total Average Rank of Target Member (from all evaluating members)

Adjust web-site defined member grouping cutoffs by degree of ease/harshness of evaluating members

Store result

Example of above procedure:

Four (4) groups were previously delineated as follows:

Group 1—Attractive votes divided by total votes=0% to 25%

Group 2—Attractive votes divided by total votes=26% to 50%

Group 3—Attractive votes divided by total votes=51% to 75%

Group 4—Attractive votes divided by total votes=76% to 100%

Assume degree of ease/harshness for a given user equals 90%.

Divide group cutoffs by 90%

Four (4) groups are now delineated as follows:

Group 1—Attractive votes divided by total votes=0% to 28%

Group 2—Attractive votes divided by total votes=29% to 56%

Group 3—Attractive votes divided by total votes=57% to 83%

Group 4—Attractive votes divided by total votes=84% to 100%

5) User Interaction: User Search Preference—Relationships User Search Preference—Friendships

Display user profile search preferences

Where category equals User Search Preference for Relationships

Set Filter_Search_Results_by_Physical_Attractiveness_Criteria_Relationship to No

Let user select whether to filter members by criteria of physical attractiveness

If user selects to filter members by criteria of physical attractiveness

Set Filter_Search_Results_by_Physical_Attractiveness_Criteria_Relationship to Yes

Let user select range above and below user's physical attractiveness ranking to filter members returned to user from user-defined database search

Store selection

Where category equals User Search Preference for Friendships

Set Filter_Search_Results_by_Physical_Attractiveness_Criteria_Friendship to No

Let user select whether to filter members by criteria of physical attractiveness

If user selects to filter members by criteria of physical attractiveness

Set Filter_Search_Results_by_Physical_Attractiveness_Criteria_Friendship to Yes

Let user select a range above and below user's physical attractiveness ranking to filter members returned to user from user-defined database search

Store selection

6) User Interaction: User Profile Display Preference During Searches By Other Members—Relationships

User Profile Display Preference During Searches By Other Members—Friendships

Display user profile display preferences

Where category equals User Profile Display Preference for Relationships

Set Restrict_Profile_Display_During_Profile_Searches_Relationships to No

Let user select whether to restrict display of user profile (to other members who are searching the profile database) by criteria of searching member's physical attractiveness

If user selects to restrict display of user profile (to other members who are searching the profile database) by criteria of searching member's physical attractiveness

Set Restrict_Profile_Display_During_Profile_Searches_Relationships to Yes

Let user select range above and below user's physical attractiveness ranking to enable display of user's profile to only those members falling within selected range

Store selection

Where category equals User Search Display Preference for Friendships

Set Restrict_Profile_Display_During_Profile_Searches_Friendships to No

Let user select whether to restrict display of user profile (to other members who are searching the profile database) by criteria of searching member's physical attractiveness

If user selects to restrict display of user profile (to other members who are searching the profile database) by criteria of searching member's physical attractiveness

Set Restrict_Profile_Display_During_Profile_Searches_Friendships to Yes

Let user select range above and below user's physical attractiveness ranking to enable display of user's profile to only those members falling within selected range

Store selection

7) Obtain Profile Database Search Result: Relationship/Friendship

Relationship Search:

Where Filter_Search_Results by_Physical_Attractiveness_Criteria_Relationship equals Yes

Define User's_Calculated_Range equal to user's physical attractiveness group plus user selected upward search range for relationships plus user selected downward search range for relationships

While not at end of list

If user has ranked member then if user provided ranking equals Not attractive do next member

If member physical attractiveness group is within User's_Calculated_Range

If member has set Restrict_Profile_Display_During_Profile_Searches_Relationships to No

Include member in relationship search result

If member has set Restrict_Profile_Display_During_Profile_Searches_Relationships to Yes

If member has ranked user then if member provided ranking equals Not attractive do next member

Define Member's_Calculated_Range equal to user's physical attractiveness group plus member selected upward search range for relationships plus member selected downward search range for relationships

If user physical attractiveness group is within Member's_Calculated_Range

Include member in relationship search result

Repeat

Display profile database relationship search result

Friendship Search:

Where Filter_Search_Results_by_Physical_Attractiveness_Criteria_Friendship equals Yes

Define User's_Calculated_Range equal to user's physical attractiveness group plus user selected upward search range for friendships plus user selected downward search range for friendships

While not at end of list

If user has ranked member then if user provided ranking equals Not attractive do next member

If member physical attractiveness group is within User's_Calculated_Range

If member has set Restrict_Profile_Display_During_Profile_Searches_Friendships to No

Include member in friendship search result

If member has set Restrict_Profile_Display_During_Profile_Searches_Friendships to Yes

If member has ranked user then if member provided ranking equals Not attractive do next member

Define Member's_Calculated_Range equal to user's physical attractiveness group plus member selected upward search range for friendships plus member selected downward search range for friendships

If user physical attractiveness group is within Member's_Calculated_Range

Include member in friendship search result

Repeat

Display profile database friendship search result

8) User Interaction: User Profile Display Preference While In Chat Rooms—Relationships

User Profile Display Preference While In Chat Rooms—Friendships

Display user profile display preferences

Where category equals User Profile Display Preference for Relationships

Set Restrict_Profile_Display_While_In_Chat_Rooms_Relationships to No

Let user select whether to restrict display of user profile (while user is in chat room) by criteria of physical attractiveness of other members in the same chat room

If user selects to restrict display of user profile (while user is in chat room) by criteria of physical attractiveness of other members in the same chat room

Set Restrict_Profile_Display_While_In_Chat_Rooms_Relationships to Yes

Let user select range above and below user's physical attractiveness ranking to enable display (while user is in chat room) of user's profile to only those members falling within selected range

Store selection

Where category equals User Search Display Preference for Friendships

Set Restrict_Profile_Display_While_In_Chat_Rooms_Friendships to No

Let user select whether to restrict display of user profile (while user is in chat room) by criteria of physical attractiveness of other members in the same chat room

If user selects to restrict display of user profile (while user is in chat room) by criteria of physical attractiveness of other members in the same chat room

Set Restrict_Profile_Display while_In_Chat_Rooms_Friendships to Yes

Let user select range above and below user's physical attractiveness ranking to enable display (while user is in chat room) of user's profile to only those members falling within selected range

Store selection

9) Restrict Profile Display while in Chat Rooms: Relationship/Friendship

Relationship Restriction:

Where Restrict_Profile_Display_While_In_Chat_Rooms_Relationships equals Yes

Define User's_Calculated_Range equal to user's physical attractiveness group plus user selected upward search range for relationships plus user selected downward search range for relationships

For each member in chat room (while not at end of list)

If user has ranked member then if user provided ranking equals Not attractive do next member

If member physical attractiveness group is within User's_Calculated_Range

Display user to member

Repeat

Friendship Restriction:

Where Restrict_Profile_Display_While_In_Chat_Rooms_Friendships equals Yes

Define User's_Calculated_Range equal to user's physical attractiveness group plus user selected upward search range for friendships plus user selected downward search range for friendships

For each member in chat room (while not at end of list)

If user has ranked member then if user provided ranking equals Not attractive do next member

If member physical attractive group is within User's_Calculated_Range

Display user to member

Repeat

User Interface

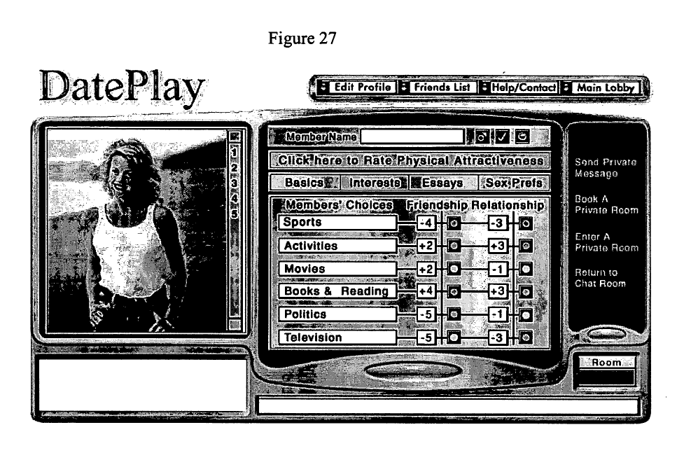

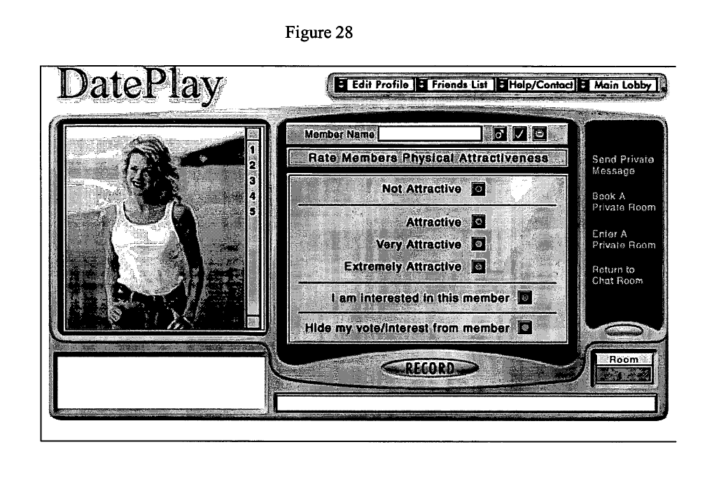

The first embodiment of the “physical attractiveness” feature of the present invention thus allows the user of a dating site to filter potential friends/mates using physical attractiveness as a criteria. FIG. 27 provides a sample snapshot of a profile screen for a hypothetical member. In this example, the user has chosen to review the Interests section of the hypothetical member. Above the Interests button is a button titled “Click here to Rate Physical Attractiveness”. Once the user clicks the Physical Attractiveness button, a new screen (FIG. 28) is displayed on which the user can provide a specific ranking of the degree to which the user finds the member to be physically attractive. The user selects a ranking and also whether to notify the member that the user has selected a ranking. The user finishes the interaction by clicking the RECORD button whereupon the user is returned to the screen pictured in FIG. 27. The user may revisit the ranking screen of FIG. 28 at a later date and review or revise his/her ranking.

The ranking provided by the user is compiled to the database. Rankings provided by other members are also compiled to the database. Based on the rankings provided by all users who ranked this member, the member is placed within a group of members and the groups are delineated by the level to which users found the member to be physically attractive. As noted above, different users may judge member pictures more easily or harshly than all the members as a whole. To address this, a ratio is determined and then applied to adjust the cutoffs used to delineate the groups.

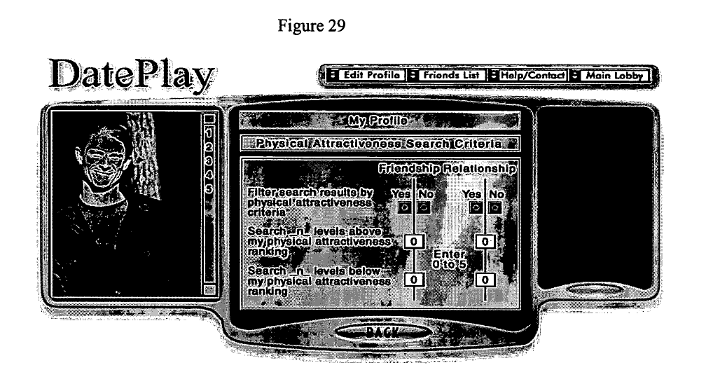

As illustrated in FIG. 29, users can search the member database employing the criteria of physical attractiveness to filter the list of members who are returned for their review.

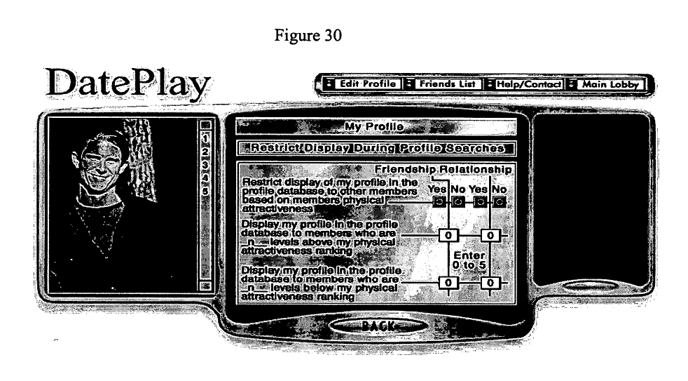

As shown in FIG. 30, users also can restrict the display of their profile to other members within the member database based on the other members' physical attractiveness.

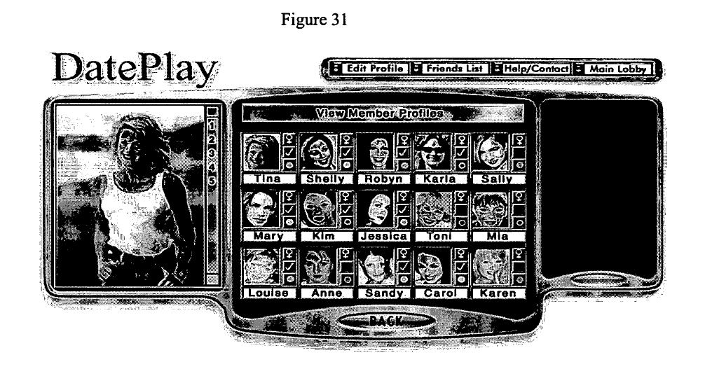

FIG. 31 illustrates a sample screen showing search results including members meeting physical attractiveness criteria and any other selected criteria that are returned for review by the user.

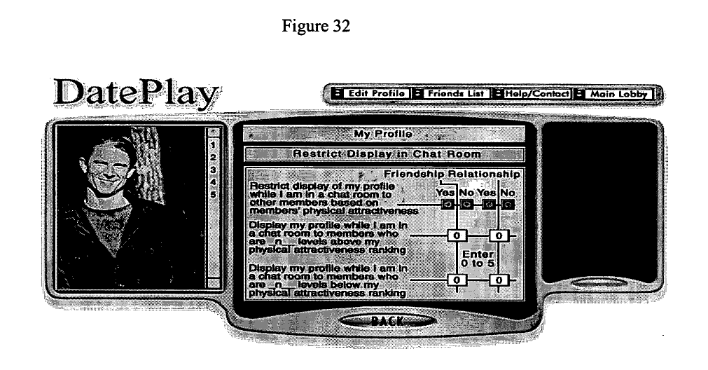

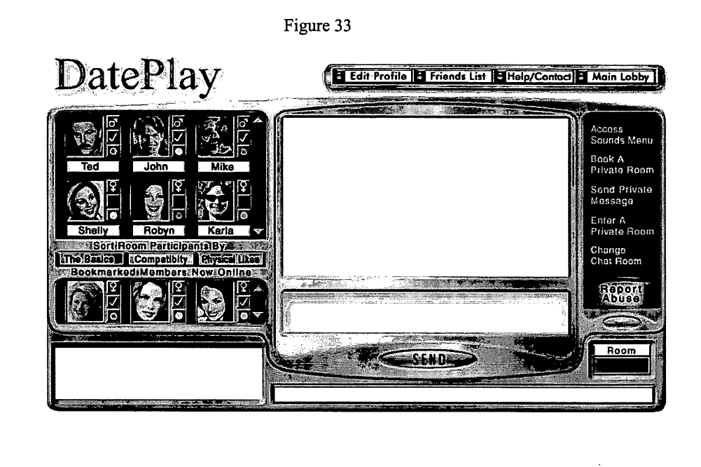

Using, for example, the screen illustrated in FIG. 32, users can restrict the display of their profile while in a chat room to other members within the member database based on the other members' physical attractiveness. As shown in FIG. 33, members may appear or not appear to other members in a chat room based on display criteria including members' physical attractiveness and member selections concerning display of their profile while in chat rooms.

### The Second Embodiment of the Physical Attractiveness Evaluation

In accordance with a second embodiment of the “physical attractiveness” evaluation feature of the invention, the system creates attractiveness pools for user groupings. For example, the system may elect to create 10 pools where the first pool is the lower boundary (users chosen as least attractive by other members) and the tenth pool is the upper boundary (users chosen as most attractive by other members). A rating description table is created to hold the rating pool numbers and rating pool descriptions. The system may also create a system ranking table which holds the user's ID, the user's system rank, the target member ID, the rating given to a target member by the user, and the date the rating was inserted and/or updated. The system also creates a member attractiveness table to hold the system pool number, the target member ID, and the target member's average rating.

A user becomes a member of the system by completing a member application identifying member interests, basic user information, and a picture of the member. As in the first method, each member of the member pool is evaluated as to his/her physical attractiveness by other members of the pool. The evaluation is based on pictures provided by the member and is separated into ten primary categories, “1 through 10” to reflect whether a member is not attracted to the featured member which would result in a score of 1, extremely attracted to the featured member which would result in a score of 10, or attracted to some level between 2 and 9. Alternatively, the second method could employ the same groupings as are used by the first method. In either case, the logic of the method will remain the same.

A score ranging between 1 and 10 to measure the physical attractiveness of the target member to the evaluating member is specified and stored by the web-site for future database manipulation. Preferably, no member learns the scores of other members nor the scores associated with his/her own profile. When members wish to review the pool of members as sorted by physical attractiveness to the reviewing member, referred to below as member 2000, then member 2000 will specify a range below and above member 2000's ranking to instruct the website to display the profiles of other members falling within that range.

As in the first method, it may be hypothesized that less attractive members of a community may tend to give higher rankings to more attractive people than would be given by other more attractive members of the community while; similarly, more attractive members of the community may tend to give lower rankings to less attractive people than would be given by other less attractive members of the community. Such bias may be removed from the system by relating the perspective of a given member, in this case member 2000, to the perspective of other members about member 2000. Further, the members who are forming judgment about member 2000 have themselves been judged and categorized by other members of the pool. The methodology is as follows.

Member scores are placed into ten groups, A through J, each corresponding to the series of potential rankings 1 through 10. Member 2000, a heterosexual male, joins the site. Over time, various members rank member 2000 using a range between 1 through 10. The web-site maintains a record of the rankings that have been applied to the female members of the pool. Consequently, the system knows that a given female member may be ranked as a 1 by male members who are themselves predominantly ranked as 8's.

| | Female is | Dominant |
|---|---|---|
| | predominantly | Rank of |
| | ranked by | Evaluating |
| Group | male group as | Male Members |
| A | 1 | 8 |
| B | 2 | 7 |
| C | 3 | 7 |
| D | 4 | 7 |
| E | 5 | 6 |
| F | 6 | 5 |
| G | 7 | 4 |
| H | 8 | 4 |
| I | 9 | 3 |
| J | 10 | 3 |

The methodology breaks down into two parts—female members who member 2000 will find attractive and female members who will find member 2000 attractive. There is a different approach to each query. As to female members who member 2000 will find attractive, the system does the following: First, the web-site asks member 2000 for a range of rankings relative to his own. Specifically, member 2000 is asked to specify a range below and above his own ranking for which he is interested in viewing the profiles of other members. Assume member 2000 responds that he is interested in viewing profiles that are ranked 2 points below his own ranking and 3 points above his own ranking as seen in the table above. The results in the table will be used to illustrate how profiles are assembled in response to member 2000's search inquiry.

The system will obtain the table of attractiveness rankings for each female member meeting any other criteria specified by member 2000 such as location and age parameters. The table of the example female member indicates that she is viewed by male members, who are predominantly ranked as 7's, as being in groups B, C and D which carry rankings of 2, 3, and 4. Assuming that member 2000 is predominantly ranked as a 7, if member 2000 has elected to search one level above and four levels below his own ranking, then the range of acceptable females to member 2000 will be between 3 and 8. The female member is viewed as a 2, 3, and 4 and will be preliminarily included in the search result since at least one of her ranks falls within member 2000's search range. As described in below, the next step is to determine whether member 2000 is within the female's range. The logic works in the same manner. If the female has elected to restrict the display of her profile based on physical attractiveness, then the female's range is obtained from the database and the system refers to member 2000's ranking table to determine the rank in which he is viewed by the female members of the community who have a predominate ranking equivalent to that of the female member and whether that rank is within the female's range.

The user may also decide what pools he/she wants to be visible to. For example, a user may choose to be available for searches in all pools two above and one below his/her pool. The only limitation is the logical upper and lower bounds of the pools themselves. That is, if there are 10 pools, and the user is a member of pool 10, though the user interface may allow the user to choose to be viewed by other users in pools two above his/her pool, the system will appreciate that there are no pools above the user's pool and will discount the selection. However, this information is saved so that if the user drops to a lower pool the user will become visible to the appropriate pools. The user may change this limitation at any time.

Similarly, the user may decide what pools he/she wishes to search within by specifying the number of pools above and below his/her pool to consider in a search. The user may change this limitation at any time as well. Those “target members” returned in the search will be within the user's “physical attractiveness” boundaries and will be those members who also match any other specified preference criteria.

Thus, the present invention provides a mechanism where members rated as “not attractive” by the searcher are automatically deleted from any search results and members not rated by the searcher but collectively rated as being outside of the searcher's range for “physical attractiveness” also may be deleted from the search results. This methodology answers the common complaint discussed above concerning a member's desire not to be approached by members that the member being approached is not likely to find attractive. Besides being judged an annoyance, the fact of unwanted approaches is a major reason members quit dating services. As such, this “physical attractiveness” feature of the invention is a substantial improvement over current online dating systems.

Pseudocode

The second “physical attractiveness” method of the invention may be implemented in the matching (search) software loaded on the online dating service's website. Sample pseudocode for implementing the techniques of the second method are set forth below:

1) User Interaction: Evaluation of Target Member

Display (target) member for evaluation (by evaluator)

Let evaluator assign a rank from 1 to 10 of physical attractiveness of target member

Let evaluator select whether to notify target member that a ranking has been assigned.

Do not disclose ranking to target member.

Record assigned ranking and Dominant Rank of Evaluator in database

2) Derive Table of Perspective-based Ranks of Target Member

Define the database equivalent of a five column table with fixed data as follows:

| | target | Accumulated | Number of | Averaged |
|---|---|---|---|---|
| | Member | Rank | Evaluators in | Dominant Rank |
| Group | Rank | of Evaluator(s) | Group | of Evaluator(s) |
| A | 1 | | | |
| B | 2 | | | |
| C | 3 | | | |
| D | 4 | | | |
| E | 5 | | | |
| F | 6 | | | |
| G | 7 | | | |
| H | 8 | | | |
| I | 9 | | | |
| J | 10 | | | |

For each ranking received for the target member (while not at end of list)

[Numerator] For the assigned target member rank, increase value of Accumulated Rank of Evaluator(s) by Dominant Rank of Evaluator

[Denominator] For the assigned target member rank, increment value of Number of Evaluators in Group by one (1)

Repeat (while not at end of list)

For each Group (while not at end of list)

Divide accumulated numerator by accumulated denominator

Round result

Store result as Averaged Dominant Rank of Evaluator(s)

Repeat while not at end of list

Example of above procedure (using hypothetical data):

| | Target | Accumulated | Number of | Averaged |
|---|---|---|---|---|
| | Member | Rank of | Evaluators in | Dominant Rank |
| Group | Rank | Evaluator(s) | Group | of Evaluator(s) |
| A | 1 | 1,998 | 222 | 9 |
| B | 2 | 4,250 | 500 | 9 |
| C | 3 | 8,000 | 1,000 | 8 |
| D | 4 | 6,300 | 900 | 7 |
| E | 5 | 35,000 | 5,000 | 7 |
| F | 6 | 36,000 | 5,100 | 6 |
| G | 7 | 2,000 | 400 | 5 |
| H | 8 | 0 | 0 | |
| I | 9 | 1,900 | 600 | 3 |
| J | 10 | 300 | 150 | 2 |

3) Derive Dominant Rank of Target Member

For each Group that ranked the target member (while not at end of list)

Multiply the Number of Evaluators in Group times Validity Factor for each Vote from Group

Repeat (while not at end of list)

Sort Group by highest Equivalent Number of Evaluators

Select highest Group from sort.

In event of equal Equivalent Number of Evaluators within sort group, choose highest Group letter.

Example of above procedure:

| | | Number of | Validity factor | Equivalent |
|---|---|---|---|---|
| | Target Member | Evaluators in | for each Vote | Number of |
| Group | Rank | Group | from Group | Evaluators |
| A | 1 | 222 | 5.00 | 1,110 |
| B | 2 | 500 | 2.00 | 1,000 |
| C | 3 | 1,000 | 1.43 | 1,430 |
| D | 4 | 900 | 1.00 | 900 |
| E | 5 | 5,000 | 0.38 | 1,900 |
| F | 6 | 5,100 | 0.38 | 1,938 |
| G | 7 | 400 | 1.00 | 400 |
| H | 8 | | 1.43 | — |
| I | 9 | 600 | 2.00 | 1,200 |
| J | 10 | 150 | 5.00 | 750 |

The Dominant Weighted Rank of the Target Member equals 6.

4) Derive Weighted Validity Factor for each Vote from Group

The previous section, Derive Dominant Rank of Target Member, compared how many members assigned a given rank for the target member. An adjustment is required to avoid an undue weighting by the natural preponderance of members who would be expected to be viewed as being of average physical attractiveness. The following algorithm is included to compensate for clusters of predominate rankings.

For all members who have provided at least one rank of another member (while not at end of list)

[Numerator] Increment Voting Members by Dominant Rank of Member

[Denominator] Increment Total Voting Members

Repeat (while not at end of list)

Store Numerator by Dominant Rank of Member (Group)

Store Total Voting Members

For each Group (while not at end of list)

Let Membership Distribution equal Numerator divided by Denominator

Let Validity Factor equal 0.10 divided by Membership Distribution

Store result by Group

Repeat (while not at end of list)

Example of above procedure:

| | Dominant | Hypothetical | | Weighted |
|---|---|---|---|---|
| | Rank | Membership | Validity factor | Hypothetical |
| | of Member | Distribution of | for each Vote | Membership |
| Group | Population | Voting Members | from Group | Distribution |
| A | 1 | 2% | 5.00 | 10% |
| B | 2 | 5% | 2.00 | 10% |
| C | 3 | 7% | 1.43 | 10% |
| D | 4 | 10% | 1.00 | 10% |
| E | 5 | 26% | 0.38 | 10% |
| F | 6 | 26% | 0.38 | 10% |
| G | 7 | 10% | 1.00 | 10% |
| H | 8 | 7% | 1.43 | 10% |
| I | 9 | 5% | 2.00 | 10% |
| J | 10 | 2% | 5.00 | 10% |
| Totals | | 100% | | 100% |

5) User Interaction: User Search Preference—Relationships

User Search Preference—Friendships

Display user profile search preferences

Where category equals User Search Preference for Relationships

Set Filter_Search_Results_by_Physical_Attractiveness_Criteria_Relationship to No

Let user select whether to filter members by criteria of physical attractiveness

If user selects to filter members by criteria of physical attractiveness

Set Filter_Search_Results_by_Physical_Attractiveness_Criteria_Relationship to Yes

Let user select rankings (from one to ten) to be included in members returned to user from user-defined database search

Store selection

Where category equals User Search Preference for Friendships

Set Filter_Search_Results_by_Physical_Attractiveness_Criteria_Friendship to No

Let user select whether to filter members by criteria of physical attractiveness

If user selects to filter members by criteria of physical attractiveness

Set Filter_Search_Results_by_Physical_Attractiveness_Criteria_Friendship to Yes

Let user select rankings (from one to ten) to be included in members returned to user from user-defined database search

Store selection

6) User Interaction: User Profile Display Preference During Searches By Other Members—Relationships

User Profile Display Preference During Searches By Other Members—Friendships

Display user profile display preferences

Where category equals User Display Preference for Relationships

Set Restrict_Profile_Display_During_Profile_Searches_Relationships to No

Let user select whether to restrict display of user profile (to other members who are searching the profile database) by criteria of searching member's physical attractiveness

If user selects to restrict display of user profile (to other members who are searching the profile database) by criteria of searching member's physical attractiveness

Set Restrict_Profile_Display_During_Profile_Searches_Relationships to Yes

Let user select rankings (from one to ten) of other members for which user chooses to enable display of user profile

Store selection

Where category equals User Display Preference for Friendships

Set Restrict_Profile_Display_During_Profile_Searches_Friendships to No

Let user select whether to restrict display of user profile (to other members who are searching the profile database) by criteria of searching member's physical attractiveness

If user selects to restrict display of user profile (to other members who are searching the profile database) by criteria of searching member's physical attractiveness

Set Restrict_Profile_Display_During_Profile_Searches_Friendships to Yes

Let user select rankings (from one to ten) of other members for which user chooses to enable display of user profile

Store selection

7) Obtain Profile Database Search Result: Relationship/Friendship

Relationship Search:

Where Filter_Search_Results_by_Physical_Attractiveness_Criteria_Relationship equals Yes

Obtain user's dominant physical attractiveness rank

Define User's_Evaluated_Range equal to specific physical attractiveness rankings selected by user

Define User's_Calculated_Range equal to user's dominant physical attractiveness rank plus user selected upward search range for relationships plus user selected downward search range for relationships

While not at end of list

If user has ranked member then if user provided ranking is not within User's_Evaluated_Range do next member

From member's table of Perspective-based Ranks, obtain member's Closest Target Member Rank relative to user's dominant physical attractiveness rank

If member's Closest Target Member Rank is within User's_Calculated_Range

If member has set Restrict_Profile_Display_During_Profile_Searches_Relationships to No

Include member in relationship search result

If member has set Restrict_Profile_Display_During_Profile_Searches_Relationships to Yes

Where member has ranked user

Define Member's_Evaluated_Range equal to specific physical attractiveness rankings selected by member

If member provided ranking is not within Member's_Evaluated_Range do next member

Obtain member's dominant physical attractiveness rank

From user's table of Perspective-based Ranks, obtain user's Closest Target Member Rank relative to member's dominant physical attractiveness rank

If user's Closest Target Member Rank is within Member's_Calculated_Range for profile display

Include member in relationship search result

Repeat

Display relationship search result

Friendship Search:

Where Filter_Search_Results_by_Physical_Attractiveness_Criteria_Friendship equals Yes

Obtain user's dominant physical attractiveness rank

Define User's_Evaluated_Range equal to specific physical attractiveness rankings selected by user

Define User's_Calculated_Range equal to user's dominant physical attractiveness rank plus user selected upward search range for friendships plus user selected downward search range for friendships

While not at end of list

If user has ranked member then if user provided ranking is not within User's_Evaluated_Range do next member

If user provided ranking is not within User's_Evaluated_Range do next member

From member's table of Perspective-based Ranks, obtain member's Closest Target Member Rank relative to user's dominant physical attractiveness rank

If member's Closest Target Member Rank is within User's_Calculated_Range

If member has set Restrict_Profile_Display_During_Profile_Searches_Friendships to No

Include member in friendship search result

If member has set Restrict_Profile_Display_During_Profile_Searches_Friendships to Yes

Where member has ranked user

Define Member's_Evaluated_Range equal to specific physical attractiveness rankings selected by member

If member provided ranking is not within Member's_Evaluated_Range do next member

Obtain member's dominant physical attractiveness rank

From user's table of Perspective-based Ranks, obtain user's Closest Target Member Rank relative to member's dominant physical attractiveness rank

If user's Closest Target Member Rank is within Member's_Calculated_Range for profile display

Include member in friendship search result

Repeat

Display friendship search result

8) User Interaction: User Profile Display Preference While In Chat Room—Relationships

User Profile Display Preference While In Chat Room—Friendships

Display user profile display preferences

Where category equals User Profile Display Preference for Relationships

Set Restrict_Profile_Display_While_In_Chat_Room_Relationships to No

Let user select whether to restrict display of user profile (while user is in Chat Room) by criteria of physical attractiveness of other members in the same Chat Room

If user selects to restrict display of user profile (while user is in Chat Room) by criteria of physical attractiveness of other members in the same Chat Room

Set Restrict_Profile_Display_While_In_Chat_Room_Relationships to Yes

Let user select rankings (from one to ten) to enable display (while user is in Chat Room) of user's profile to only those members falling within selected range

Store selection

Where category equals User Search Display Preference for Friendships

Set Restrict_Profile_Display_While_In_Chat_Room_Friendships to No

Let user select whether to restrict display of user profile (while user is in Chat Room) by criteria of physical attractiveness of other members in the same Chat Room

If user selects to restrict display of user profile (while user is in Chat Room) by criteria of physical attractiveness of other members in the same Chat Room

Set Restrict_Profile_Display_While_In_Chat_Room_Friendships to Yes

Let user select rankings (from one to ten) to enable display (while user is in Chat Room) of user's profile to only those members falling within selected range

Store selection

9) Restrict Profile Display while in Chat Room: Relationship/Friendship

Relationship Restriction:

Where Restrict_Profile_Display_While_In_Chat_Room_Relationships equals Yes

Obtain user's dominant physical attractiveness rank

Define User's_Evaluated_Range equal to specific physical attractiveness rankings selected by user

Define User's_Calculated_Range equal to user's physical attractiveness group plus user selected upward search range for relationships plus user selected downward search range for relationships

For each member in Chat Room (while not at end of list)

If user has ranked member then if user provided ranking is not within User's_Evaluated_Range do next member

From member's table of Perspective-based Ranks, obtain member's Closest Target Member Rank relative to user's dominant physical attractiveness rank

If member's Closest Target Member Rank is within User's_Calculated_Range

Display user to member

Repeat

Friendship Restriction:

Where Restrict_Profile_Display_While_In_Chat_Room_Friendships equals Yes

Obtain user's dominant physical attractiveness rank

Define User's_Evaluated_Range equal to specific physical attractiveness rankings selected by user

Define User's_Calculated_Range equal to user's physical attractiveness group plus user selected upward search range for Friendships plus user selected downward search range for Friendships

For each member in Chat Room (while not at end of list)

If user has ranked member then if user provided ranking is not within User's_Evaluated_Range do next member

From member's table of Perspective-based Ranks, obtain member's Closest Target Member Rank relative to user's dominant physical attractiveness rank

If member's Closest Target Member Rank is within User's_Calculated_Range

Display user to member

Repeat

User Interface

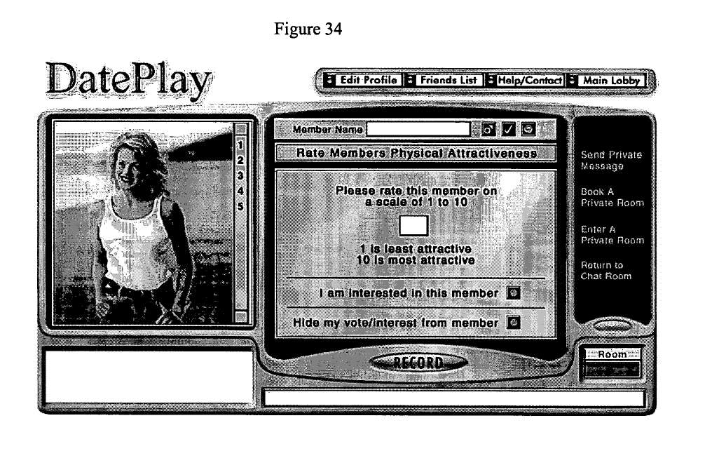

The second embodiment of the “physical attractiveness” feature of the present invention also allows the user of a dating site to filter potential friends/mates using physical attractiveness as a criteria. As in the first example above, the user may choose to review the Interests section of the hypothetical member, as illustrated in FIG. 27. Above the Interests button is a button titled “Click here to Rate Physical Attractiveness.” The user clicks the Physical Attractiveness button. A new screen (FIG. 34) is displayed on which the user can provide a specific ranking of the degree to which the user finds the member to be physically attractive. The user selects a ranking on scale of 1-10 and also determines whether to notify the member that the user has selected a ranking. The user finishes the interaction by clicking the RECORD button whereupon the user is returned to the screen of FIG. 27. The user may revisit the ranking screen of FIG. 34 at a later date and review or revise his/her ranking.

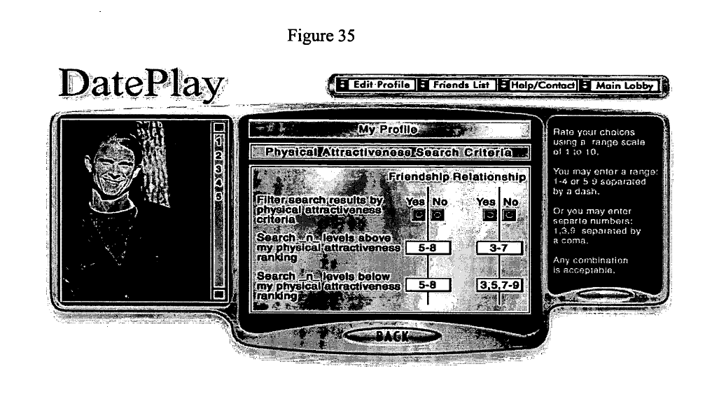

Next, as explained in pseudocode steps 2 and 3 above, the ranking provided by the user in conjunction with the user's dominant rank as seen by the other members of the member's database is compiled to a table for the target member. Users can search the member database employing the criteria of physical attractiveness to filter the list of members who are returned for their review. For example, as shown in FIG. 35, users may specify whether to use physical attractiveness as a criterion and may specify the number of levels above and below that user's ranking to accept in the search.

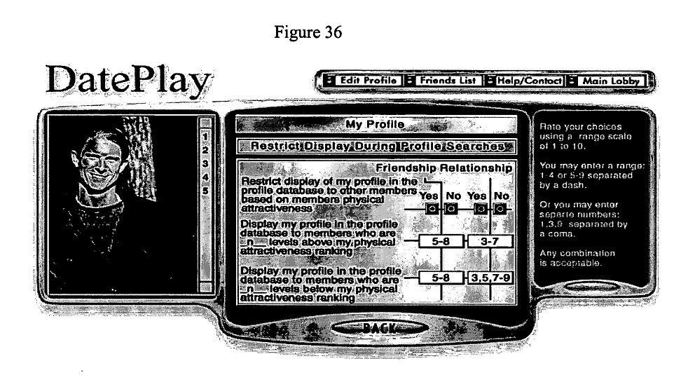

As shown in FIG. 36, users also can restrict the display of their profile to other members within the member database to certain levels above and below the user's level based on the other members' physical attractiveness. Members meeting such physical attractiveness criteria and any other selected criteria of the type explained in detail above are returned for review. The returned information is displayed in a screen like that illustrated in FIG. 31.

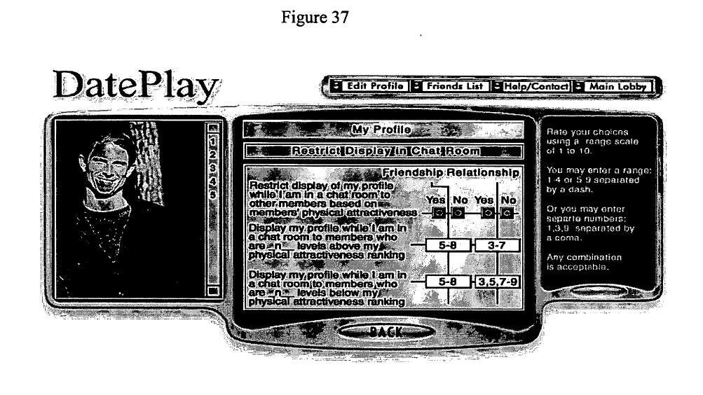

As shown in FIG. 37, users also can restrict the display of their profile while in a chat room to other members within the member database based on the other members' physical attractiveness. As a result, members appear or do not appear to other members in a chat room based on display criteria including members' physical attractiveness and member selections concerning display of their profile while in chat rooms. A sample “results” screen is illustrated in FIG. 33.

From the above description, it should be readily apparent that numerous other modifications and combinations of the above disclosure may be made without departing form the scope of the present invention. For example, while the above disclosure refers to a single web server 11 or chat server, the algorithms described may be implemented on any number of nodes with or without web server or chat server software. In addition, the weighting algorithms described herein need not be performed for an entire chat room but may be used to determine if individuals have matching interests, particularly those who find each other to be physically attractive. Further, the algorithms and processes are intended as specific implementations only and are not intended to delimit the scope of the invention, which should instead be understood with reference to the following claims.

What is claimed:

1. A method for matching members of an online community based on interest based compatibility to each other, comprising the steps of:
accepting input from respective members indicating the degree of subscription or non-subscription the respective members have to predetermined interests on a scale of least interested to most interested;
determining interest-based compatibility between members by comparing scaled inputs for respective interests based on at least one of a total number of matching interests and a degree of alignment among matching interests; and
matching members of the online community on the basis of the determined interest-based compatibility.

2. A method as in claim 1, wherein said step of determining interest-based compatibility includes the steps of comparing a scaled input for each interest for respective members, in the case of mutual interest or mutual disinterest in a predetermined interest, incrementing a count of common perspectives, and assessing the degree of compatibility between the respective members as a function of the count of common perspectives.

3. A method as in claim 1, wherein said step of determining interest-based compatibility includes the steps of comparing a scaled input for each interest for respective members, in the case of mutual interest or mutual disinterest in a predetermined interest, incrementing a count of common perspectives and obtaining an absolute difference between each member's scaled input for the interest, and assessing the degree of compatibility between respective members as a function of the total of absolute differences for respective interests divided by the count of common perspectives.

4. A method as in claim 2, comprising the further step of ignoring interests in said step of determining interest-based compatibility unless both members are interested in the predetermined interest or both members are not interested in the predetermined interest.

5. A method as in claim 3, comprising the further step of ignoring interests in said step of determining interest-based compatibility unless both members are interested in the predetermined interest or both members are not interested in the predetermined interest.

6. A method for matching members of an online community based on activity based compatibility to each other, comprising the steps of:
accepting input from respective members indicating the amount of importance the member ascribes to participation in a respective activities on a scale of least important to most important;
determining activity-based compatibility between members by comparing scaled inputs for respective activities based on at least one of a total number of matching activity importance indicators and a degree of alignment among matching activity importance indicators; and
matching members of the online community on the basis of the determined activity-based compatibility.

7. A method as in claim 6, wherein said step of determining activity-based compatibility includes the steps of comparing a scaled input for each activity importance indicator for respective members, in the case of mutual interest or mutual disinterest in the activity, incrementing a count of common perspectives, and assessing the degree of compatibility between the respective members as a function of the count of common perspectives.

8. A method as in claim 6, wherein said step of determining activity-based compatibility includes the steps of comparing a scaled input for each activity importance indicator for respective members, in the case of mutual interest or mutual disinterest in the activity, incrementing a count of common perspectives and obtaining an absolute difference between each member's scaled input for the activity, and assessing the degree of compatibility between respective members as a function of the total of absolute differences for respective activities divided by the count of common perspectives.

9. A method as in claim 7, comprising the further step of ignoring interests in said step of determining activity-based compatibility unless both members are interested in the activity or both members are not interested in the activity.

10. A method as in claim 8, comprising the further step of ignoring interests in said step of determining activity-based compatibility unless both members are interested in the activity or both members are not interested in the activity.

11. A web server that delivers web pages to members of an online community based on personal profile characteristics including common interests of the respective members, comprising:
a member database;
a central processing unit with associated memory; and
software comprising instructions stored in said associated memory, wherein when said software is executed by said central processing unit, web pages are made available to the respective members of the online community that function to:
accept input from respective members indicating the degree of subscription or non-subscription the respective members have to predetermined interests on a scale of least interested to most interested;
determine interest-based compatibility between members by comparing scaled inputs for respective interests based on at least one of a total number of matching interests and a degree of alignment among matching interests; and
match members of the online community on the basis of the determined interest-based compatibility.

12. A server as in claim 11, wherein said software compares a scaled input for each interest for respective members, in the case of mutual interest or mutual disinterest in a predetermined interest, increments a count of common perspectives, and assesses the degree of compatibility between the respective members as a function of the count of common perspectives.

13. A server as in claim 11, wherein said software compares a scaled input for each interest for respective members, in the case of mutual interest or mutual disinterest in a predetermined interest, increments a count of common perspectives and obtains an absolute difference between each member's scaled input for the interest, and assesses the degree of compatibility between respective members as a function of the total of absolute differences for respective interests divided by the count of common perspectives.

14. A server as in claim 12, wherein said software ignores interests for determining interest-based compatibility unless both members are interested in the predetermined interest or both members are not interested in the predetermined interest.

15. A server as in claim 13, wherein said software ignores interests for determining interest-based compatibility unless both members are interested in the predetermined interest or both members are not interested in the predetermined interest

16. A web server that delivers web pages to members of an online community based on personal profile characteristics including common activities of the respective members, comprising:
a member database;
a central processing unit with associated memory; and
software comprising instructions stored in said associated memory, wherein when said software is executed by said central processing unit, web pages are made available to the respective members of the online community that function to:
accept input from respective members indicating the amount of importance the member ascribes to participation in a respective activities on a scale of least important to most important;
determine activity-based compatibility between members by comparing scaled inputs for respective activities based on at least one of a total number of matching activity importance indicators and a degree of alignment among matching activity importance indicators; and
match members of the online community on the basis of the determined activity-based compatibility.

17. A server as in claim 16, wherein said software compares a scaled input for each activity for respective members, in the case of mutual interest or mutual disinterest in a predetermined activity, increments a count of common perspectives, and assesses the degree of compatibility between the respective members as a function of the count of common perspectives.

18. A server as in claim 16, wherein said software compares a scaled input for each activity for respective members, in the case of mutual interest or mutual disinterest in a predetermined activity, increments a count of common perspectives and obtains an absolute difference between each member's scaled input for the activity, and assesses the degree of compatibility between respective members as a function of the total of absolute differences for respective activities divided by the count of common perspectives.

19. A server as in claim 17, wherein said software ignores activities for determining activity-based compatibility unless both members are interested in the predetermined activity or both members are not interested in the predetermined activity.

20. A server as in claim 18, wherein said software ignores activities for determining activity-based compatibility unless both members are interested in the predetermined activity or both members are not interested in the predetermined activity.
